(19) United States
(12) Patent Application Publication
(10) Pub. No.: US 2003/0101085 A1
(43) Pub. Date: May 29, 2003

(54) Method and system for vendor communication

(76) Inventors: Herbert F. Butler III, Simpsonville, SC (US); Robin Houseknecht, Albany, NY (US); Cyndi Jones, Greer, SC (US); Wayne T. Myers, Pittsfield, MA (US); Robert Pitt, Liberty, SC (US)

Correspondence Address: PERKINS COIE LLP, PATENT-SEA, P.O. BOX 1247, SEATTLE, WA, 98111-1247, US

(21) Appl. No.: 09/989,712

(22) Filed: Nov. 20, 2001

(51) Int. Cl. G06F 17/60

(52) U.S. Cl. 705/9

(57) ABSTRACT

A method and system for vendor communication is provided. The method and system allow management and documentation of the lifecycle of a contract that is outsourced to a vendor by and enterprise. Embodiments include a vendor communication software application (“VC” application) that centralizes documentation of communications between enterprise actors and vendor actors and any actions by any actor during execution of tasks associated with an outsourced package. The VC application provides a single point of input for information related to an outsourced package that can be used by the actors. Interactions with the VC application take place during the execution of the task in order to move the execution of the task forward, effectively forcing compliance with package requirements and the documentation of the same. The VC application is also compatible with legacy systems so that legacy data can be efficiently used. In one embodiment, the VC application is a hosted Internet application.

### TECHNICAL FIELD

The described technology relates generally to centralized project management and particularly to a receiving, storing, and processing one set of data accessible to various entities and related to a complex project.

### BACKGROUND

Enterprises that design and execute complex projects typically contract for part of the project, or the entire project, to be performed by one or more vendors. For example, large-scale engineering or construction tasks are often undertaken by one enterprise that employs many vendors to perform subtasks. One example of a large-scale engineering project is the design of a power plant. The design of the power plant involves many subtasks, such as designing the building, designing the HVAC system, designing the placement of the equipment (e.g., turbines and generator), and so on. The enterprise that is responsible for designing the power plant can contract with a different vendor to perform each of the subtasks. Because of the complexity of such a project and the number of vendors who may be used, it can be very difficult to generate formal requirements documents for the vendors and consistently monitor the performance of the vendors. Current techniques for defining, assigning, tracking and reviewing tasks performed by vendors are inefficient and inadequate. FIG. 1 is a block diagram of a conventional enterprise-vendor system 100 for defining and executing vendor task(s). The documents that formally define vendor tasks are sometimes referred to as an outsourced package. The documents are typically electronic data. An outsourced package may include definitions of one or more tasks. The terms “package” and “task” will be used interchangeably herein refer to documents formally describing collections of tasks and tasks.

The system 100 includes an enterprise 102 communicating with multiple vendor organizations 114, 122, and 134. The enterprise 102 includes an enterprise database 104 for storing data to be archived, including data related to projects undertaken on behalf of customers. The enterprise 102 further includes multiple enterprise computers such as computer 110 and 108. The enterprise computers have various roles in executing the project, including defining, assigning, and monitoring outsourced packages. The enterprise 102 also employs a data management system 106, which will be referred to as the legacy system 106. The legacy system 106 is used by the enterprise computers 108 and 110 for generating and modifying documents, including documents related to outsourced packages. The legacy system 106 may be specifically designed for facilitating outsourcing activities, or it may be a generalized system used for all kinds of document management activities.

Typically, the enterprise 102 defines vendor tasks, including task standards, requested completion dates, and estimated completion times in numbers of hours. A defined vendor task is communicated to an assigned vendor 114, 122, or 134 as a document or set of documents. For example, enterprise 102 may outsource engineering and drafting tasks that feed manufacturing activities, or material requirements planning (MRP) tasks. An enterprise actor using the enterprise computers creates outsourced packages 108 and 110 and the legacy system 106. An outsourced package, such as the package 112 (which is arbitrarily designated outsourced package “A”), is assigned to a vendor, in this example vendor 114. The outsourced package 112 is a collection of electronic data, or documents in various formats including text formats, computer aided design (CAD) formats, and graphic formats. Example formats (indicated by well-known file extension) include DOC, TXT, XLS, GIF, PDF and TIFF, etc.

The outsourced package 112 is sent to the vendor 114 via a network 113, for example the Internet. The vendor 114 has its own vendor database 116 and various vendor computers such as computer 118 and computer 120. Vendor 114 actors receive the outsourced package and take actions to perform the assigned task(s) using the computers 118 and 120. The vendor actors further document actions taken and communicate with the enterprise as the task is being completed. Each of the vendors 122 and 134 has similar databases 124 and 136, respectively, as well as computers 126, 128, 130, and 132 operated by respective actors.

The system 100 has several significant disadvantages, as illustrated in FIG. 2. FIG. 2 is a block diagram of the system 100 after the performance of the task(s) associated with the outsourced package. For example, as the task is being completed, many communications may occur between the vendor 114 and the enterprise 102. There is no mechanism to assure consistent documentation of the communication or the resultant changes in the nature of the task or the course of its completion. This can cause significant problems, including the uncontrolled evolution of the task definition, and noncompliance with state, federal, and contractual requirements. Typically, communications between the vendor 114 and the enterprise 102 during the completion of the task occur by electronic mail (“email”) and telephone, or possibly by letter, and are not reflected in the package 112. The result is various forms of documentation 204 being exchanged between the vendor 114 and the enterprise 102 during and possibly after the completion of the task. The outsourced package 202 reflects modifications made by both the vendor 114 and the enterprise 102 (the modified package is designated “A1”). At the completion of work on the outsourced package, the outsourced package documents 202 are stored in the enterprise database 104 along with various documents 208 that are related to the outsourced package, but are not associated with it in the database 104. The vendor 114 stores various documents 206 that are related to the outsourced package 202, but are not necessarily retrievable based on that relationship. The documents 206 are not accessible to the enterprise 102, which may not even be aware of them.

This inadequate documentation of the lifecycle of the outsourced package is extremely inefficient, and also potentially harmful to the relationship between the vendor 114 and the enterprise 102. For example, changes that are “approved” by an enterprise actor may not be appropriately documented. Such improperly documented changes can result in completion dates that are later than originally defined, or a completed task that may not comply with original definitions. In addition, the progress of the task is slowed during its execution due to lack of readily available information and the resultant confusion.

These problems are exacerbated for the enterprise because every vendor, including vendor 122 and vendor 134 has its own database (124 and 136, respectively) and its own computers (126, 128, and 130, 132, respectively). Thus a large project with outsourced tasks assigned to multiple vendor may have extremely deficient and fragmented documentation by the time of completion.

The legacy system 106 also has disadvantages. The legacy system 106 is an example of an existing proprietary legacy software application such as some enterprises use to manage outsourcing activities. The tasks are created under an outsourced package by a scheduler against a customer order. The delivery dates and related attributes are assigned to tasks using preloaded business logic, and the tasks are allotted to respective vendors, or outsource units, for completion. Upon completion of a task, the vendor furnishes the completion dates and time taken for the activity. The enterprise undertakes review of the completed task and either accepts the delivery or orders rework. Some types of packages, however, cannot be maintained and managed through existing legacy applications, such as the legacy system 106, and are forwarded to vendors via email, for example using a pre-formatted work request document. The vendors communicate progress information using email and eventually email package documents for review and inspection.

Current legacy systems are not robust enough to handle package feedback, quality inputs, outputs and measurements. Current systems do not provide true workflow digitization that assures compliance with state, federal, and contractual specifications. Current systems also do not provide end-to-end documentation that reflects the current state of a task and is accessible to both the vendor and the enterprise.

### BRIEF DESCRIPTION OF THE DRAWINGS

FIG. 1 is a block diagram of a prior art enterprise-vendor system during an outsourced package assignment and performance.

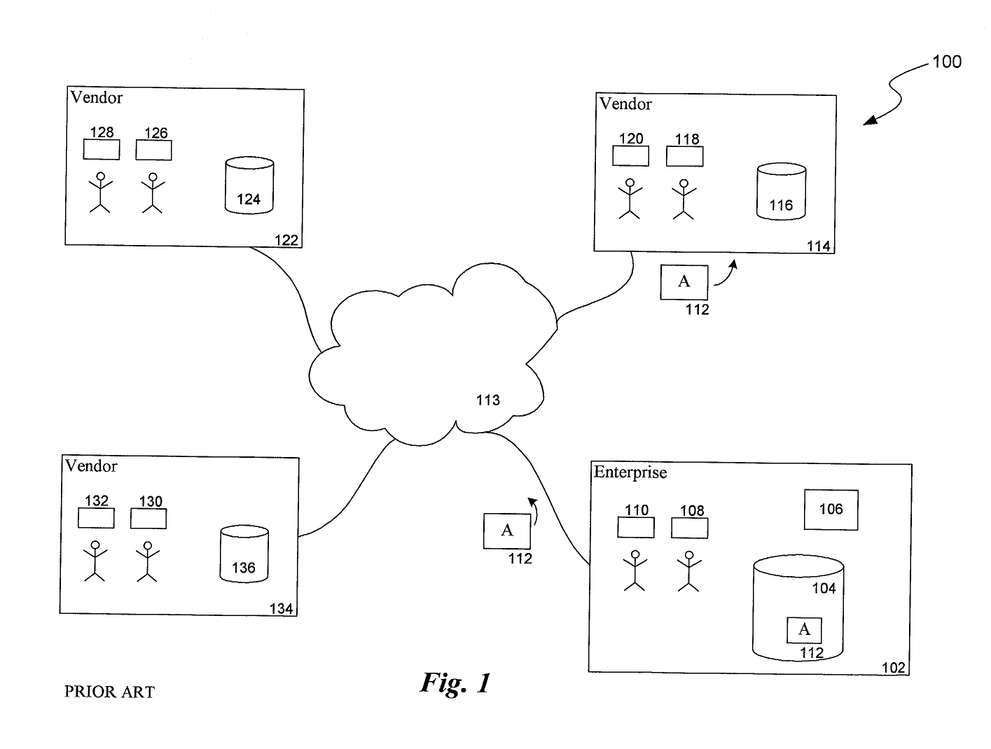

FIG. 2 is a block diagram of the system of FIG. 1 after the performance of the task(s) associated with the outsourced package.

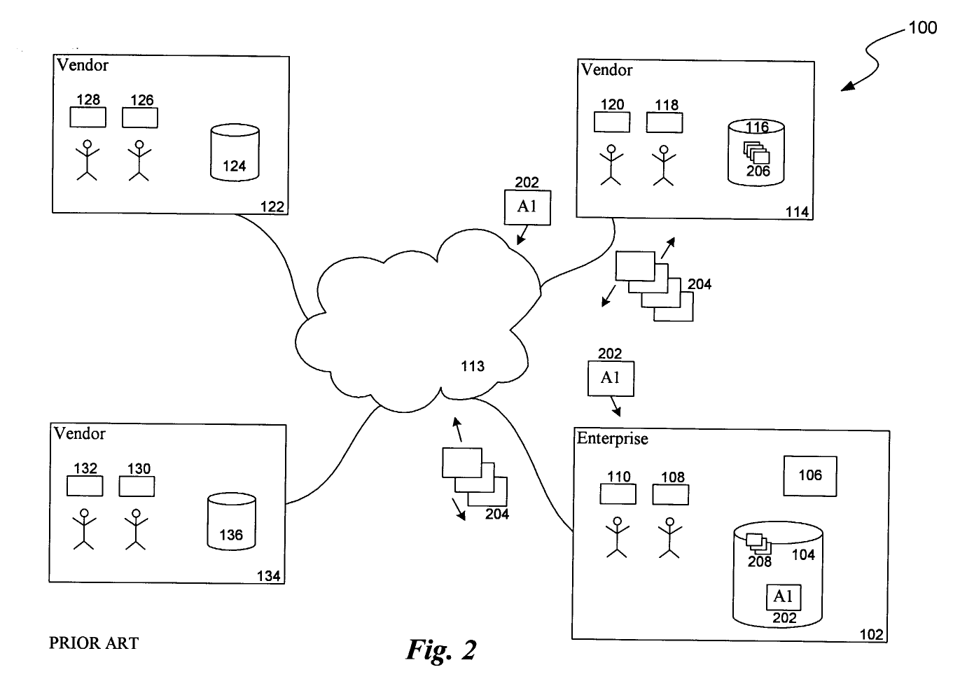

FIG. 3 is a block diagram of one embodiment of a vendor communication (“VC”) system during an outsourced package assignment and performance.

FIG. 4 is a block diagram of the system of FIG. 3 after the performance of the task(s) associated with the outsourced package.

FIG. 5 is a block diagram illustrating an embodiment of an architecture for a vendor communication system.

FIG. 6 is a block diagram of one embodiment of a vendor communication application user hierarchy.

FIG. 7 is a flow diagram of an example lifecycle of an outsourced package according to an embodiment of the VC application.

FIG. 8 is a flow diagram illustrating the importation of outsourced tasks and relevant data from a legacy application and a legacy database.

FIG. 9 is a flow diagram illustrating a use case that allows the enterprise drafter/engineer to create a new non-legacy task.

FIG. 10 is a flow diagram illustrating a use case that includes assigning a task to responsible vendor drafter/engineers.

FIG. 11 is a flow diagram illustrating a use case for requesting more information.

FIG. 12 is a flow diagram illustrating a use case in which enterprise personnel provide the task related information requested by vendor.

FIG. 13 is a flow diagram illustrating a use case that allows the vendor drafter/engineer personnel to acknowledge and work on the assigned task.

FIG. 14 is a flow diagram illustrating a use case that allows vendor drafter/engineer personnel to submit the completed task to the enterprise unit for review.

FIG. 15 is a flow diagram illustrating a use case that allows the VC application to import task completion related information for previously assigned tasks from the legacy system.

FIG. 16 is a flow diagram of illustrating a use case that allows an enterprise unit drafter/engineer to review a submitted task.

FIG. 17 is a flow diagram illustrating a use case that allows an enterprise unit drafter/engineer to send feedback to the vendor after quality review of a task.

FIG. 18 is a flow diagram illustrating a use case that allows a vendor drafter/engineer to acknowledge feedback after the quality review.

FIG. 19 is a flow diagram illustrating a use case that allows the enterprise unit drafter/engineer to send feedback and action items to a vendor after quality review of a task.

FIG. 20 is a flow diagram illustrating a use case that allows a vendor drafter/engineer to acknowledge feedback and undertake necessary follow-up action after quality review of a task.

FIG. 21 is a flow diagram illustrating a use case that allows an enterprise unit drafter/engineer to approve the actions taken by the vendor.

FIG. 22 is a flow diagram illustrating a use case that allows an enterprise high level general manager to maintain outsource restrictions.

FIG. 23 is a flow diagram illustrating a use case that allows an enterprise administrator to maintain business groups information.

FIG. 24 is a flow diagram illustrating a use case that allows an enterprise business unit manager to create and maintain cross reference data on time required by a vendor to complete a task.

FIG. 25 is a flow diagram illustrating a use case in which the VC application “cleans” input data from a legacy application.

FIG. 26 is a flow diagram illustrating a use case in which the VC application integrates an imported task record from a legacy application to a set of reference/master data objects that exist in the VC application.

FIG. 27 is an illustration of a user interface login screen in one embodiment.

FIG. 28 is an illustration of a user interface work queue screen in one embodiment.

FIG. 29 is an illustration of a user interface new task screen in one embodiment.

FIG. 30 is an illustration of a user interface update task screen in one embodiment.

FIG. 31 is an illustration of a user interface search screen in one embodiment.

FIG. 32 is an illustration of a user interface search results screen in one embodiment.

### DETAILED DESCRIPTION

A method and system for enterprise-vendor communication is provided.

Embodiments include a vendor communication software application (“VC” application) that centralizes documentation of communications and actions by any actor during execution of tasks associated with an outsourced package. The VC application provides a single point of input for information related to an outsourced package that can be used by the actors. Interactions with the VC application by various enterprise and vendor actors take place during the execution of the task in order to move the execution of the task forward, effectively forcing compliance with package requirements and the documentation of the same. The VC applicaion is also compatible with legacy systems so that legacy data can be efficiently used. Because legacy data can be used in the VC application, the time and effort spent in entering the legacy data is not wasted. In one embodiment, the VC application is a hosted Internet application.

In one embodiment, the VC application has access to predefined objects, which are part of an available platform, such as an eMatrix™ architecture. An active object broker accesses an enterprise database and a legacy database to populate the objects as required by the VC application. In one embodiment, the enterprise database includes available database software applications, such as those provided by Oracle™.

Various actors access the VC application through one or more user interfaces at varying levels of privilege as assigned by an enterprise administrator. In one embodiment, the VC application is hosted over the Internet. An enterprise actor can access the appropriate user interface over an enterprise Intranet, and by a vendor actor over the Internet. Through the user interface, the various actor gain access to an enterprise database that stores data related to ongoing and completed outsourced tasks. The user interface includes forms that assist the various actors in entering the specific information required for uniform data collection related to the task.

The VC application user interface assist various actors in creating and performing outsourced tasks. Two-way communication between the vendor and the enterprise occurs through the VC application, for example, requests for information, replies to requests for information, performance reviews and ratings, posting of key dates, changes to key dates, and compliance with restrictions, such as export restrictions, including required documentation of the same. All data input into the VC application related to an outsourced package is archived in an enterprise database in compliance with any relevant requirements, such as the requirements of ISO certification.

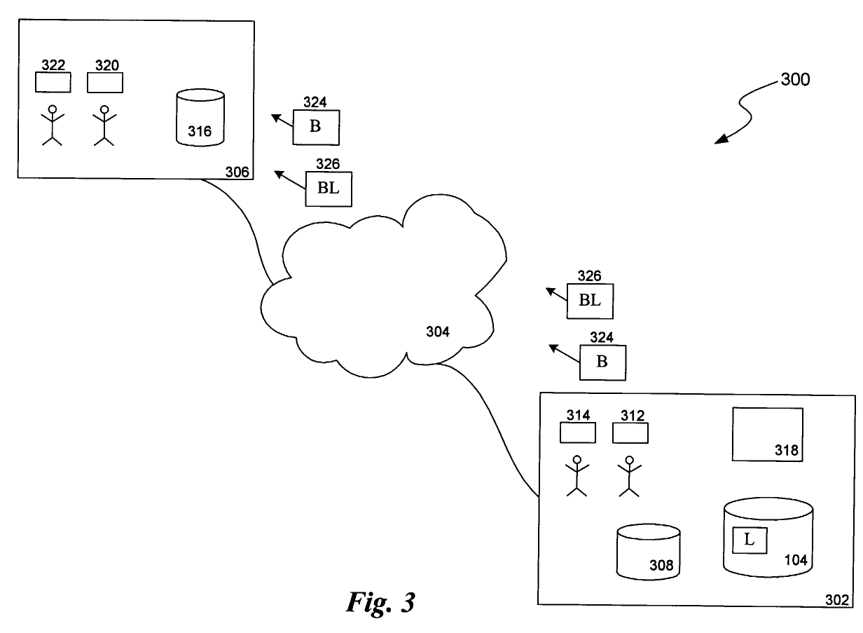

FIG. 3 is a block diagram of one embodiment of a vendor communication (“VC”) system 300 during the process of defining and performing an outsourced package. The VC system 300 includes an enterprise 302, which is an entity that undertakes large and/or complex projects for customers. The VC system 300 includes a VC application server 310 that runs a VC application, an enterprise database 308, and a legacy database 104. In alternative embodiment, the databases/and or servers shown are distributed, including distributed across the network 304. The legacy database 104 stores data related to outsourced packages and tasks that were created using a legacy system. The enterprise 302 further includes computers 312 and 314, which are operated by enterprise actors, such as administrators of the VC application, engineers, drafters, and others. The VC application that runs on the VC application server 310, as will be further described, manages all communication between the enterprise 302 and a vendor, such as vendor 306, that performs an outsourced task. The vendor 306 includes vendor computers 320 and 322, and a vendor database 316. In one embodiment, the vendor 306 accesses the VC application server 310 using the vendor computers 320 and 322 and a network, such as the Internet. The VC application facilitates the creation and management of the task and assures appropriate archiving of all data related to completed tasks in the database 308. The VC application is further compatible with the legacy data stored in the legacy database 104 to allow efficient use of task data previously entered using the legacy system or application (not shown). In one embodiment, the VC application server 310 is physically separated from the databases 104 and 308 to avoid spoofing.

After the creation of an outsourced package, such as outsourced packages 324 and 326, the outsourced package is sent to an assigned vendor 306 via a network 304. The network 304 can be any network that transmits conventional electronic data, such as the Internet. The outsourced package 324 is created using the VC application and is arbitrarily designated as package “B”. The outsourced package 326 is created using the VC application, and at least some legacy data. The package 326 is arbitrarily designated as package “BL”.

The outsourced packages 324 and 326 are available to the vendor 306 through a user interface of the VC application which is operated on the vendor computers 320 and 322 by various vendor actors to access the VC application. In one embodiment, the VC application is hosted from the enterprise 302 so that access to the VC application functionality and to the databases 104 and 308 is through the user interface available to the vendor 306. In alternate embodiments, the vendor 306 can include a client software application (not shown) to allow the vendor to interface with the VC application. In other embodiments, the VC application and the databases 104 and 308 are distributed across various locations. A single user interface provides access via a network to all users of the VC application. The users are each assigned secure, personalized access to the VC application that includes a level of privilege appropriate to their role. In particular, every actor of one particular vendor can only access the data related to the vendor, and cannot access data related to any other vendor. A particular actor may be able to access data related to only one task, or one phase of one task as necessary. In one embodiment, an enterprise administrator with the highest level of privilege provides each user with access, including appropriate privileges and password(s).

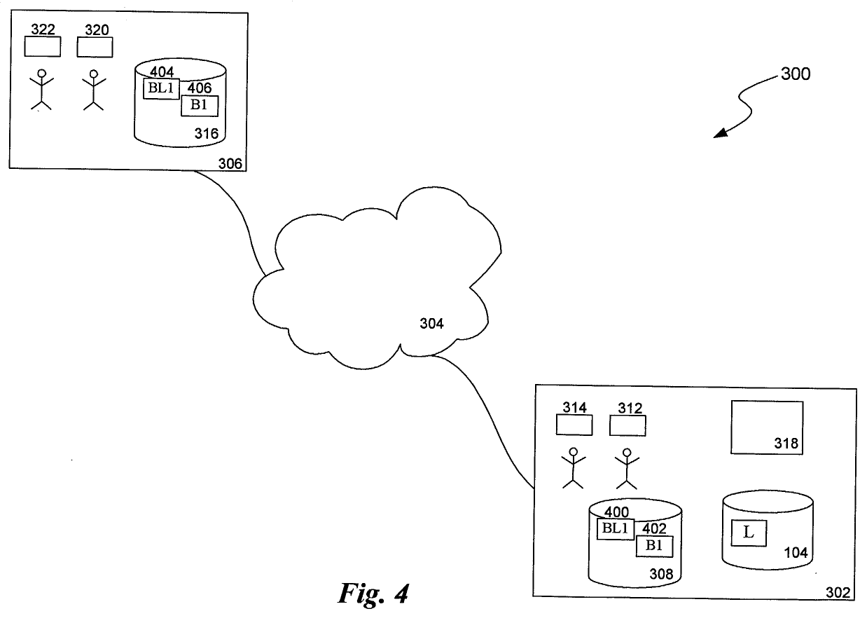

FIG. 4 is a block diagram of the system 300 after the performance of the task(s) associated with the outsourced package. During the process of performing the outsourced package, all entries to the packages 324 and 326 occur through the user interface of the VC application. These constitute modifications of the documents that make up the outsourced packages. The outsourced packages 400 and 402 are the outsourced packages 324 and 326 as modified after the completion of all tasks included in the outsourced packages. The outsourced packages 400 and 402 include not only modifications to the original documents, but any additions that may be in a form not originally encompassed by the outsourced packages 324 and 326. The outsourced packages 400 and 402 are stored in the enterprise database 308. Optionally, the vendor also stores versions of the outsourced packages 404 and 406 that are all of the data related to the outsourced packages that is appropriate for the vendor 306 to possess. In this manner, the status of an outsourced package is available to any actor who needs to have it at any time during the process of completing the package. In addition, all data related to the process of completing the package is stored in an easily identifiable and accessible way.

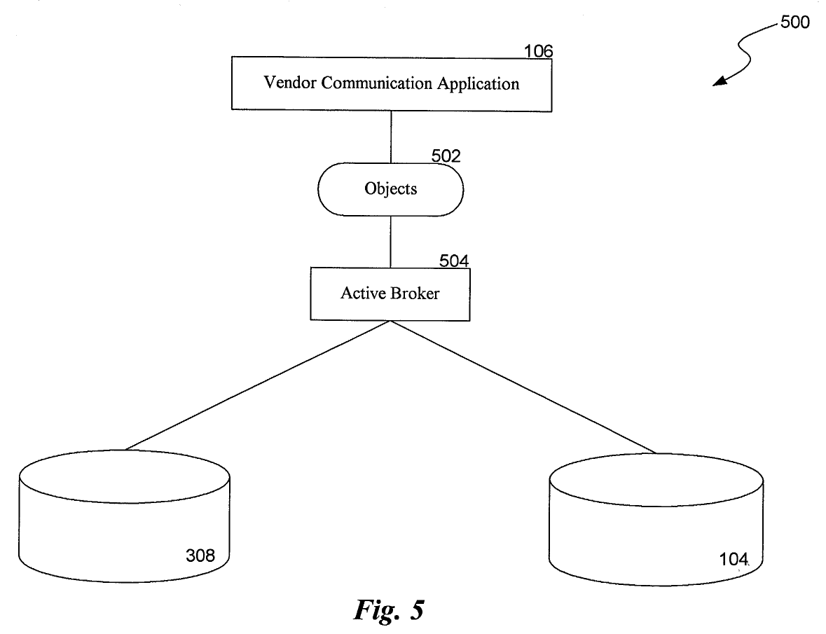

FIG. 5 is a high-level block diagram illustrating an embodiment of an architecture for a vendor communication system 500. The VC application has access to predefined objects 502. In one embodiment, the predefined objects 502 are part of an available platform, such as an eMatrix™ architecture. An active object broker 504 accesses the enterprise database 308 and the legacy database 104 to populate the objects 502 as required by the VC application 106. In one embodiment, the enterprise database 308 includes available database software applications, such as those provided by Oracle™.

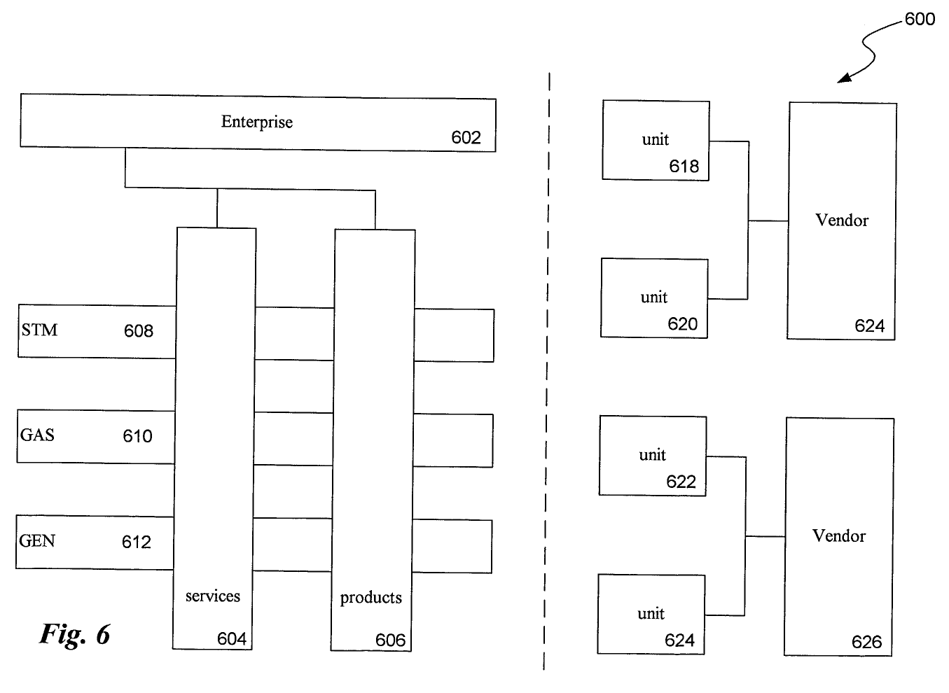

FIG. 6 is a block diagram of one embodiment of a VC application user hierarchy. The hierarchy 600 is applicable to an example enterprise and vendors with to whom the enterprise assigns tasks. In this example, the enterprise undertakes large engineering projects, for example power plant construction and maintenance. The enterprise outsources many of the engineering, analysis, and drafting tasks to various vendors. The product provided by the vendor at the completion of a task is a document or documents. This example will be used to facilitate the following description of the VC application. The VC application is accessible to different groups of users in both the enterprise organization and the vendor organizations. The VC application understands and applies a particular pattern of organizational hierarchy for workflow digitization and controlling access to the VC application and data.

An enterprise 602 is at the top of the hierarchy 600. In the embodiment of FIG. 6, there are different business groups under the enterprise 602. For example, an energy services business group 604, and an energy products business group 606 are shown. There are several business units associated with the business groups 604 and 606. Business units steam 608, gas, 610, and generator 612 are shown. Each of the business groups 608, 610, and 612 may outsource work packages of different business units, such as the business units 604 and 606.

In one embodiment, particular outsource organizations are preferred by the enterprise. For example, there are “low cost center vendors” that have particular identifiers. Each vendor organization has several outsource units which each have unique identifier codes. Enterprise business units are each indicated by a particular code. For example, steam business unit 608 is identified as STM, gas business unit 610 is identified as GAS, and generator business unit 612 is identified as GEN. A responsible enterprise business unit indicates a vendor and a specific unit of the vendor to which the task is to be outsourced. The responsible initial of the task indicates a vendor drafter/engineer assigned to execute the task. Vendors 624 and 626 each have various outsource units suitable to perform different kinds of outsourced tasks. The vendor 624 has outsource units 618 and 620. The vendor 626 has outsource units 622 and 624.

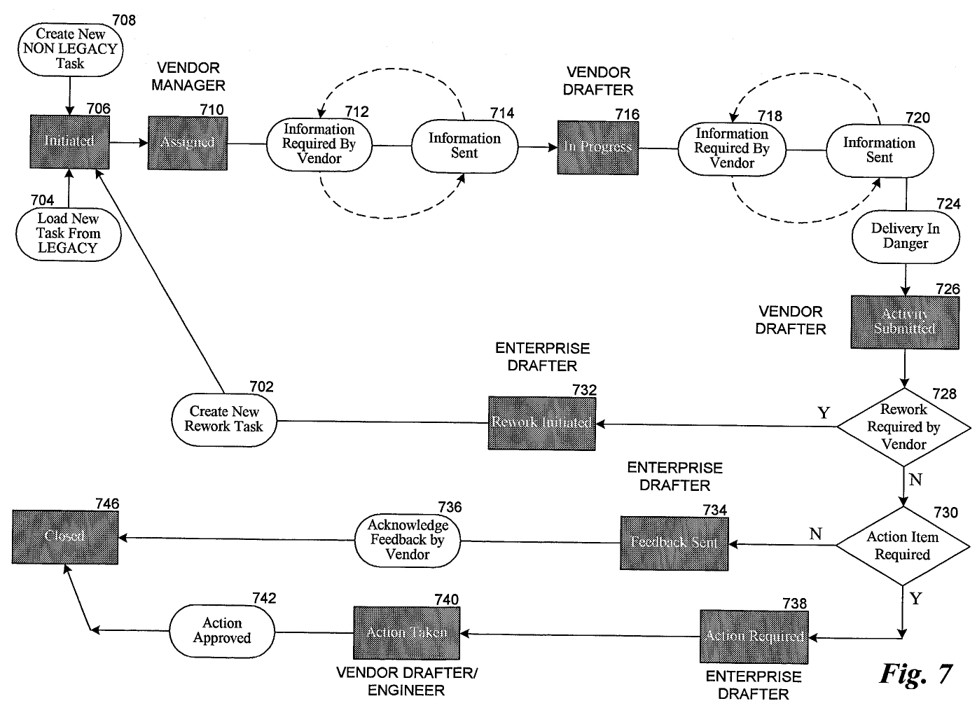

FIG. 7 is a flow diagram of an example lifecycle of an outsourced package according to an embodiment of the VC application. The lifecycle states are identified after understanding the interactions involved between vendor actors and enterprise actors during the process of task execution. Documented processes of existing proprietary or non-proprietary workflow digitization legacy application (for example statement of work (“SOW”), outsource tracking tool (“OTT”), and user acceptance test (“UAT”)) developed or under development at the enterprise may be referred to. In the example of FIG. 7, the lifecycle of a task in the VC application is composed of nine states including a final “CLOSED” state. The execution sequence of these states, the associated responsible role(s), and the activities involved with each are described below.

Various actors have access to the VC application. Some of the actors and their interactions with the VC application will now be described. An enterprise drafting manager accesses reporting tools of the VC application, for example, to see what the status of projects are and what the outlook workload is. The reporting tools further give an indication of what the quality has been, how many hours are being charged to projects etc. An enterprise drafting manager typically requires the ability to build queries and extract data as needed. The enterprise drafting manager also accesses the VC application to maintain a master list with completion date and estimated completion time information. Each enterprise drafting manager is associated with a single enterprise business group.

An enterprise drafter/engineer accesses the VC application to initiate and track individual projects and to respond to technical questions. The enterprise drafter/engineer undertakes review and inputs feedback on the quality of submitted activities. The enterprise drafter/engineer must approve the review work done against the delivered tasks and initiate rework or an action item, if any are required from vendor side. Each enterprise drafter/engineer is associated with a single enterprise business group.

A vendor manager accesses the VC application to ensure that team members are assigned, requested dates are met, and action items are undertaken. The vendor manager uses the VC application to build queries and extract data as needed. An actor associated with one vendor cannot access data of another vendor.

A vendor drafter/engineer accesses the VC application to monitor his or her workload and to communicate any technical questions they may have. The vendor drafter/engineer also uses the VC application to communicate that their project is in danger of missing a delivery date.

An enterprise high-level general manager accesses the VC application to ensure that all outsourced volume is captured and measured. The enterprise general manager requires access to a reliable source for metrics data, which is supplied by the VC application with minimum data compilation time and effort. The enterprise general manager further accesses the VC application to verify that export control and intellectual property checklists are completed for each outsourced package. The enterprise general manager builds queries and extracts data as needed on an enterprise level.

An enterprise VC application administrator accesses the VC application to create application users and to create application user logins. The application administrator further maintains master/reference information related to business units, business groups, and vendors. A vendor outsource administrator also administers data importation, including referential integrity of imported data, and performance of the application itself.

An application demon is a virtual actor that facilitates automated data importation, for example from legacy applications at regular intervals.

The lifecycle of an example outsourced task will now be described with reference to FIG. 7, which summarizes the lifecycle states of an outsourced task, or package. Rectangular, shaded blocks indicate a state of the process. Rounded, unshaded blocks indicate an activity in the lifecycle of an outsourced task. A task to be outsourced to a vendor from an enterprise may be loaded from a legacy application at block 704. Alternatively a new task to be outsourced may be created using only the VC application as shown at block 708. All new tasks which are assigned to a vendor, as shown at block 710, have the status ‘INITIATED’, as shown at block 706. A task should have various attributes at the time of initiation, including Order Number, Activity Type, Vendor Outsource Unit code, Enterprise Initiator, Task Complexity, Late Finish Date, Requested Finish Date, Estimated Time, related documents etc.

Any rework initiated by a package reviewer follows the same workflow that a task undergoes. A vendor responds to an initiated task either by accepting the initiated task or contacting a responsible enterprise manager to discuss any concerns.

If a task loaded from a legacy application has already been allocated to a vendor drafter/engineer, the status of the tasks is ‘ASSIGNED’ instead of ‘INITIATED’. The owner of the ‘ASSIGNED’ state shown at block 710, is a vendor manager. Once any task is initiated for execution, the vendor manager allocates the responsibility to an appropriate person, such as an engineer or drafter, for execution. Once any work is allocated, the status of the task automatically changes to “ASSIGNED’. Details of related data fields are explained below.

The next state, at block 716, is ‘IN PROGRESS’. The owner of this state is the vendor drafter/engineer. Once any work is allocated, the vendor drafter/engineer changes the status of the task to ‘IN PROGRESS’.

Before starting work on the assigned task, or during execution of the task, the vendor drafter/engineer may need additional information, as shown at block 712. The vendor drafter/engineer may require additional information multiple times. For example, an information exchange is also shown at blocks 718 and 720. An attribute flag of the task switches between ‘INFORMATION REQUESTED’, as shown at blocks 712 and 718, and ‘INFORMATION SENT’, as shown at blocks 714 and 720. The enterprise expects the vendor to complete the assigned task and forward it for review.

To communicate the kind of information required, the drafter/engineer from the vendor side uses a running text format and sets the attribute flag of the task to ‘INFORMATION REQUESTED’. The drafter/engineer from the vendor side can also load any relevant documents, if required.

Enterprise personnel provide requested information in running text format. Information provided also includes documents. A compliance warning is displayed before information is sent. The compliance warning includes information, for example, about what is acceptable to transmit in accordance with any relevant export control and intellectual property policies.

After furnishing the requested information and documents, enterprise personnel reset the attribute flag of the task to ‘INFORMATION SENT’.

In the event a task deadline may not be met, this can be communicated by setting an additional attribute flag called “DELIVERY IN DANGER” in the task, as shown at block 724. The attribute flag can be set and reset by the vendor to communicate and highlight the issue and provide early warning of a possible schedule impact to an enterprise manager.

An ‘ACTIVITY SUBMITTED’ state is shown at block 726. The owner of this state of the task is the vendor drafter/engineer. Upon completion of the assigned task, the vendor requests enterprise personnel to review and provide feedback on any associated deliverable. In a case of “direct release” by the vendor this review and feedback is skipped or completed by an enterprise quality review board.

Upon completion of the task, the vendor drafter/engineer provides information, such as date of completion of the task, and time spent in hours on the task. The time spent can be gathered electronically or manually. The vendor drafter/engineer sets the status of the task to ‘REVIEW REQUESTED’.

A ‘REWORK INITIATED’ state is shown at block 732. The owner of this state of a task is a drafter/engineer of an appropriate part of the enterprise organization. The drafter/engineer inputs review observations, quality findings, and information related to the rework requirement.

When a task needs rework, as shown with a “Y” response to query block 728, the reviewer indicates whether the rework is due to a change in the scope of the task that was initiated by the enterprise, or due to nonconformance by the vendor. The reviewer also indicates the requested finish date of the rework, and an estimate of the time required for the rework.

A new rework sub-task is generated, as shown at 702, and the state of the prior task changes to “REWORK INITIATED”, as shown at block 732. The rework follows the same activity lifecycle as a new task. No further operations on the prior task are performed.

A ‘FEEDBACK SENT’ state is shown at block 734. The owner of this state of a task is a drafter/engineer of an appropriate part of the enterprise organization. The drafter/engineer inputs review observations, quality findings and rework requirement related information. The drafter/engineer provides information in three general groups.

Group1 is “rework”. If the task underwent rework by the enterprise, the enterprise provides the time spent for rework.

Group2 is “feedback”. An enterprise drafter/engineer gives feedback regarding the performance of the vendor. In one embodiment, a scale of 1-10 is used, 10 being the best. The enterprise drafter/engineer, in one embodiment, provides feedback comments in running text format, and also indicates if critical analysis is required.

Group3 is “action items”. The reviewer indicates follow up actions, if any, required from the vendor, in running text format. The reviewer may not ask for an “action item”. In this case, the status of the task changes to ‘FEEDBACK SENT’, as indicated at block 734. The vendor must accept the feedback before closing the task.

An ‘ACTION REQUIRED’ state is shown at block 738. The ‘ACTION REQUIRED’ state is entered when there is a “Yes” response to the “Action Item Required” query shown at block 730. The owner of this state of a task is a drafter/engineer of an appropriate part of the enterprise organization. The drafter/engineer inputs review observations, quality findings, and rework requirement related information.

The information the drafter/engineer provides is typically in one of the three groups, as described above.

When the reviewer asks for an action item, the status of the task changes to “ACTION REQUIRED” and the vendor can work on the action items.

An ‘ACTION TAKEN’ state is shown at block 740. The owner of this state of a task is the vendor manager. In one embodiment, there are three possible scenarios associated with an ‘ACTION TAKEN’ task. In a first scenario, an enterprise drafter/engineer sends feedback to the vendor drafter/engineer. The vendor drafter/engineer reviews the feedback, and inputs comments in a free text format.

In another scenario, the enterprise drafter/engineer asks for critical analysis. In response, the vendor drafter/engineer sends the number of critical errors and the number of non-critical errors.

In a third scenario, the enterprise drafter/engineer asks for a required Action Item. The vendor drafter/engineer undertakes follow-up action, inputs the result in running text format, and forwards the result to an enterprise manager for review and approval.

The vendor manager changes the status of the task to ‘ACTION TAKEN’, as shown at block 740, and requests the enterprise manager to review and approve the task before the task is closed.

A ‘CLOSED’ state, shown at block 746, indicates that the action has been approved at block 742 and no further action can be performed on the task. In one embodiment, the ‘CLOSED’ state is automatically set for two scenarios. In a first scenario, the status of the task changes to ‘CLOSED’ as shown at block 746, after the vendor acknowledgement of the feedback, as shown at block 736. In another scenario, the enterprise drafter/engineer requests an action item, and the vendor drafter/engineer takes the necessary action and sets the status to ‘ACTION TAKEN’. On acknowledgement of the action items by an enterprise drafter/engineer/manager, the status of the task automatically changes to ‘CLOSED’.

In cases in which a legacy system has been used, input data “in Data” is collected from the legacy application to capture the activities that have been assigned to vendors via the legacy system. It may not have been possible to schedule some items using the legacy application. In these cases, the items can be manually input. In one embodiment, additional fields in the vendor communication application supplement the fields in the legacy application for each activity. This allows inputs by both the vendor and the enterprise, so that technical information such as Technical Questions, Technical Answers, Quality Feedback, Waiting Inputs, Target Delivery, and Requested Delivery is captured.

Table 1 lists data fields identified from an existing legacy application database to upload to the VC database (“VCDB”) in one embodiment. The data fields are related to new outsourced tasks initiated in the legacy application.

New tasks from the legacy application that include a vendor responsible unit code are loaded to the VC application. Updates regarding task completion dates and actual times required for completion of preloaded tasks is also loaded from the legacy application. In one embodiment, a legacy database is scanned once daily for data to be uploaded to the VC application. Details of identified data elements in one embodiment are provided as an example in Table 1.

TABLE 1
Identified Legacy Data

| Table | | |
|---|---|---|
| and Field Name | Data Type | Remarks |
| Tistiact.Buss_Code | Char 3 | This is business unit of the |
| | | Enterprise, suxh as STM, GEN |
| Order_No | Char 10 | |
| Act_No | Char 8 | |
| Act_desc | Char 30 | |
| Original_Late_{—} | datetime | |
| Finish | | |
| Target_Finish | datetime | |
| Resource_Comp | Char 6 | This is the outsource unit code |
| | | example: SA*, SB* etc. |
| Resp_init | Char 6 | |
| Complexity | Char 6 | |
| Req_hrs_orig | float | |
| Hrs_actual | float | Data shall not be available for |
| | | a new task |
| Actual_Finish | Date Time | Data shall not be available for |
| | | a new task |
| Measurement_ind | Char 1 | |
| Update_timestamp | Date Time | |
| Tisthead.Cust_{—} | Char(30) | Do a join on tisthead table and |
| Name | | tistiact table using order_no: |
| | | as common key. |
| Design Change | | Wherever data is available |
| Reference Number | | insert ‘Y’ in vendor application |
| type Tistiact.dri_ind | | database. |

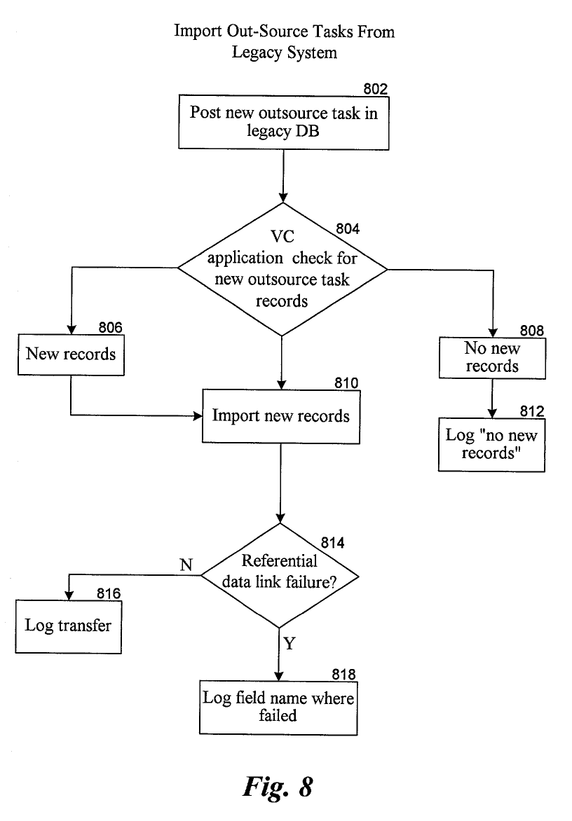

The following FIGS. 8-26 are flow diagrams that illustrate various use cases of the VC application. In one embodiment, each use case also corresponds to a particular user interface screen or screens of the VC application user interface.

FIG. 8 is a flow diagram illustrating the importation of outsourced tasks and relevant data from a legacy application and a legacy database. This use case starts when an outsourced task is posted in the legacy database at block 802. At block 804, the VC application checks the legacy database at regular intervals, such as once daily, for any new records related to outsourced tasks. In one embodiment, any new task record in the legacy system can be identified by order number, business unit code, time stamp, responsible unit code, and activity type code. If, as shown at block 808, there are no new records, this fact is logged at block 812. If new records are found as in block 806, the new record(s) are imported at block 810. A check for referential data link failure is made at block 814. If a link failure occurred, the field name at which the failure occurred is logged at block 818. The VC administrator will reestablish the link off-line. If no link failure was detected, the data transfer is logged at block 816.

In one embodiment, the data fields related to new task to be imported from the legacy system are enterprise business unit code, order number, activity type code, activity description, actual finish date, actual hours, responsible unit, estimated hour, late finish date, requested finish date, responsible initial, Design Change Reference Number activity type, customer name, measurement indicator, time stamp and complexity (OPTIONAL). Data integrity is verified with the following master data of the VC application: enterprise business unit code, responsible unit, and responsible initial.

Once task records are imported from the legacy system, a log is maintained to indicate successful transfer of data. The fields in the log can be, for example, number of records, date and time of import etc. Table 2 is a list of data fields and sample data applicable to the use case of FIG. 8.

TABLE 2

| | Sample | |
|---|---|---|
| Field Name | Data | Remarks |
| Business | STM | This field is a part of Primary Key |
| Code | | |
| (tistiact.bus_code) | | |
| Order | 1LX0269 | L means the order is large. There can be multiple tasks under |
| Number | | an order. This field is a part of Primary Key. |
| (tistiact.order_no) | | |
| Activity | UJ8PK, | If same activity type UJ8 comes more than once under same |
| Type Code/ Cost Code | UJ8, UJ8DT, | order with different suffixes; UJ8PK-The total work package,UJ8DT- |
| (tistiact. act_no) | JU8RW, UJ9 | task for the identified vendor, UJ8-the review task for enterprise, |
| | | UJ8RW-Rework by vendor. This field is a part of Primary Key. |
| Activity | CPLG | |
| Description | SPACER PLATE, | |
| (tistiact.act_desc) | LPB TE | |
| Actual | 3/16/01 | This data will not be available for a new task |
| Finish Date | | |
| (tistiact.actual_finish) | | |
| Actual Hours | 1.9 | This data will not be available for a new task. 6 Minutes is 0.1 |
| (tistiact.hrs_actual) | | hrs. |
| Responsible | SARD | This is the responsible unit of a specific vendor for specific |
| unit | | enterprise business group |
| (tistiact.resource_comp) | | |
| Requested | 1.5 | |
| Hour | | |
| (tistiact.req_hes_curr) | | |
| Late Finish | 3/16/01 | Late finish date of parent has to be considered if activity type |
| Date | | is ‘DT’ for requested finish date calculation if there is a |
| (tistiact.curr_late_finish) | | packaged task. |
| Target | 3/16/01 | |
| Finish date | | |
| (tistiact.target_finish) | | |
| Responsible | JEH | Initial of the person responsible for delivering the task |
| initial | | |
| (tistiact.resp_init) | | |
| Design | | |
| Change Reference | | |
| Number activity Type | | |
| Tistiact.dri_ind | | |
| Customer | ILLINOIS | Do a join on tisthead table and tistiact table using order_no: as |
| name | POWER CO | common key. |
| (tisthead.cust_name) | (CLINTON) | |
| Measurement | N | The ‘Y’ field is blank |
| Indicator | | |
| (tistiact.measurement_ind) | | |
| Complexity | A, B, C, | Complexity Level of the Task (OPTIONAL). |
| (tistiact.complexity) | D, 1234. | |
| Time Stamp | | This is in binary format |

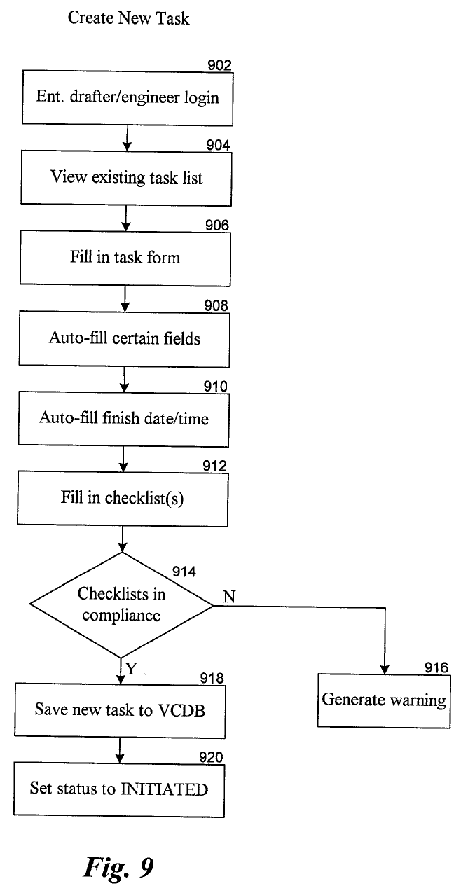

FIG. 9 is a flow diagram illustrating a use case that allows the enterprise drafter/engineer to create a new non-legacy task, provide detail information on the task and assign the same to a vendor.

This use case starts when a enterprise drafter/engineer logs into VC application to create a new task at block 902. The enterprise drafter/engineer may perform a selection card search to view an existing tasks list at block 904. The enterprise user can see the list of tasks related to the respective enterprise business group only. For a new task, the enterprise user can either copy and change data from an existing similar task as a model or the user can fill in all the required parameters in a blank format at block 906. Examples of fields that must be filled in are: order number, business unit code, customer name, activity type code, activity description, late finish date, requested finish date, responsible unit, responsible initial, complexity (optional), estimated hours, measurement indicator, charge number, and activity type. Some fields, such as vendor code, business group, enterprise initiator initial and status are automatically populated at block 908. A requested finish date and estimated time are also automatically supplied at block 910. Only the enterprise business unit drafter/engineer has the authority to edit the requested finish date and estimated time

Before saving the data into the VCDB, an outsource restriction/export control checklist must filled in by the user. This assists the VC application in determining whether the task is in compliance with any requirements and restriction rules at block 914. If the outsourced task as defined by the enterprise drafter/engineer is not in compliance, a warning is generated at block 916. The process cannot continue until the warning is eliminated by bringing the task into compliance.

If the task is in compliance, the new task is saved to the VCDB at block 918. The status of the task is set to INITIATED at block 920. Data integrity and uniqueness are verified automatically. Table 3 is a list of data fields and sample data applicable to the use case of FIG. 9.

TABLE 3

| | Sample | |
|---|---|---|
| Field Name | Data | Remarks |
| Business | STM | Select from Drop down list. |
| Unit Code | | |
| Business | ES, EP | Populate automatically |
| Group | | |
| Order | 1LX0269 | Editable |
| Number | | |
| Activity | UJ8, | Editable |
| Type Code/ Cost | UJ8DT, UJ9 | |
| Code | | |
| Activity | CPLG | Editable Text Field |
| Description | SPACER PLATE, | |
| | LPB TE | |
| Vendor | SARD | Select from drop down list. |
| Outsource unit | | |
| VC | 1.5 | To be populated from the lookup and also editable. |
| Estimated Hours | | |
| Late Finish | 3/16/01 | Editable |
| Date | | |
| VC | 3/16/01 | To be populated from the lookup and also editable. |
| Requested Finish | | Use LATE FINISH DATE as reference. |
| date | | |
| Complexity | A, B, C, | Editable (OPTIONAL) |
| | D, 1234. | |
| Customer | ILLINOIS | Editable, free format text |
| name | POWER CO | |
| | CLINTON | |
| Status | Initiated | Read only |
| enterprise | | Editable, Free format text data, document loading |
| Note | | facility to be provided. |
| Initial- | JEH | By default the initial of task entry user. |
| enterprise initiator | | |
| Outsource | Rule | The user has to fill in the comments against the rule |
| Restriction Form | description | in YES/NO format. |
| Measurement | | |
| Indicator | | |
| Design | YES/NO | Corresponding data in legacy DB is DCI01013520. |
| Change Reference | | |
| Number Type | | |
| Charge No. | | Order Number + Activity Type. (Read Only) |
| TIME | DATE | |
| STAMP | TIME | |

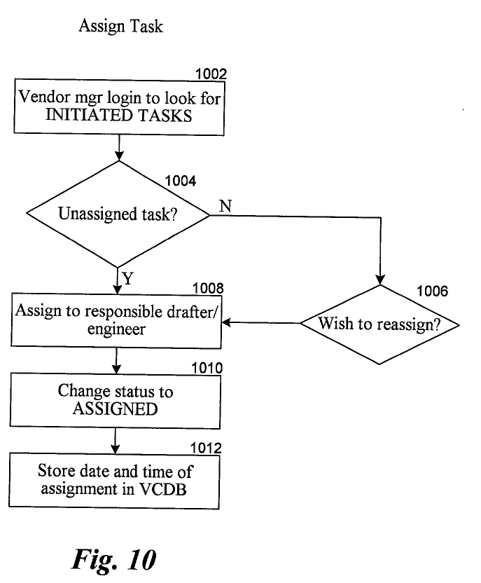

FIG. 10 is a flow diagram illustrating a use case that includes assigning a task to responsible vendor drafter/engineers. The case begins when the vendor manager logs into the VC application to view tasks with INITIATED status at block 1002. The vendor manager may search the VCDB using the VC user interface. The vendor manager can see a list of tasks assigned to the respective outsourcing unit. Users of a particular vendor organization can see the task outsourced to their organization only. The VC application determines whether each task is assigned at block 1004. If a task is assigned, the vendor manager is given an opportunity to reassign at block 1006. If the task is unassigned, the vendor manager assigns the task to a responsible vendor drafter/engineer at block 1008. The status of the task is changes to ASSIGNED. The date and time of the assignment is stored in the VC database (“VCDB”) at block 1012. In the case of a rework activity, which follows the regular task lifecycle, any rework initiated can be assigned by the vendor manager as just described. Table 4 is a list of data fields and sample data applicable to the use case of FIG. 10.

TABLE 4

| | Sample | |
|---|---|---|
| Field Name | Data | Remarks |
| Business | STM | Read Only. |
| Unit Code | | |
| Business | ES, EP | Read Only. |
| Group | | |
| Order | 1LX0269 | Read Only |
| Number | | |
| Activity | UJ8, | Read Only |
| Type Code/ Cost Code | UJ8DT, UJ9 | |
| Activity | CPLG | Read Only |
| Description | SPACER PLATE, | |
| | LPB TE | |
| Vendor | SARD | Read Only |
| Outsource unit | | |
| VC | 1.5 | Read Only |
| Estimated Hours | | |
| VC | 3/16/01 | Read Only |
| Requested Finish date | | |
| Complexity | A, B, C, | Read Only |
| | D, 1234. | |
| Customer | ILLINOIS | Read Only |
| name | POWER CO | |
| | CLINTON | |
| Status | INITIATED | Read only, shall change to ‘ASSIGNED’ |
| | | once vendor manager identifies responsible |
| | | initial. |
| enterprise | | Read Only |
| Note | | |
| Initial- | JEH | Read Only |
| enterprise initiator | | |
| Responsible | AEH | Select from a list. |
| Initial | | |
| Design | YES/NO | Read Only |
| Change Reference | | |
| Number Type | | |
| USER ID | | Automated |
| TIME | DATE: | Automated. |
| STAMP | TIME | |

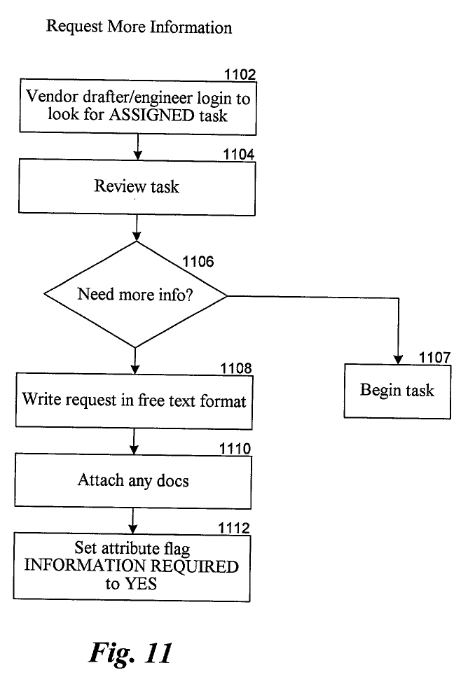

FIG. 11 is a flow diagram illustrating a use case for requesting more information. This use case allows a vendor drafter/engineer to request the enterprise to provide more information related to the assigned task. The use case begins when a vendor drafter/engineer logs into VC application to look for assigned tasks at block 1102. The vendor drafter/engineer can see a list of tasks assigned to them particularly, and review the detail of the assigned task at block 1104. After going through the detail of the assigned task, if vendor drafter/engineer determines more information is required at block 1106, he or she can write a request in free text format at block 1108. Any documents to be attached are attached at block 1110. If no additional information is required, the vendor drafter/engineer begins the task at block 1107. Any documents in electronic format can also be attached as part of the request. An information required attribute flag of the task is set to YES by the vendor drafter/engineer at block 1112. Table 5 is a list of data fields and sample data applicable to the use case of FIG. 11.

TABLE 5

| | Sample | |
|---|---|---|
| Field Name | Data | Remarks |
| Business | STM | Read Only. |
| Unit Code | | |
| Business | ES, EP | Read Only. |
| Group | | |
| Order | 1LX0269 | Read Only |
| Number | | |
| Activity | UJ8, | Read Only |
| Type Code/ Cost Code | UJ8DT, UJ9 | |
| Activity | CPLG | Read Only |
| Description | SPACER | |
| | PLATE, | |
| | LPB TE | |
| Vendor | SARD | Read Only |
| Outsource unit | | |
| VC | 1.5 | Read Only. |
| Estimated Hours | | |
| VC | 3/16/01 | Read Only |
| Requested Finish date | | |
| Complexity | A, B, C, | Read Only |
| | D, 1234. | |
| Customer | ILLINOIS | Read Only |
| name | POWER CO | |
| | CLINTON | |
| Status | | Read Only All the previous |
| History | | statuses and Dates which the |
| | | task under went. |
| Status | ASSIGNED/ | Read only. |
| | IN PROGRESS | |
| Requested | Free | The request has to be |
| Information | format text | explained. |
| Attachment | DOC, | Vendor shall load any |
| | XLS, GIF, | document if it has to be |
| | PDF,TXT etc: | communicated to enterprise |
| Information | NO | Editable, the vendor shall |
| Required | | change to YES if required. |
| enterprise | | Read Only |
| Note | | |
| Initial- | JEH | Read Only |
| enterprise initiator | | |
| Responsible | AEH | Read Only |
| Initial | | |
| Design | YES/NO | Read Only |
| Change Reference | | |
| Number Type | | |
| USER ID | | Automated |
| TIME | DATE: | Automated. |
| STAMP | TIME | |

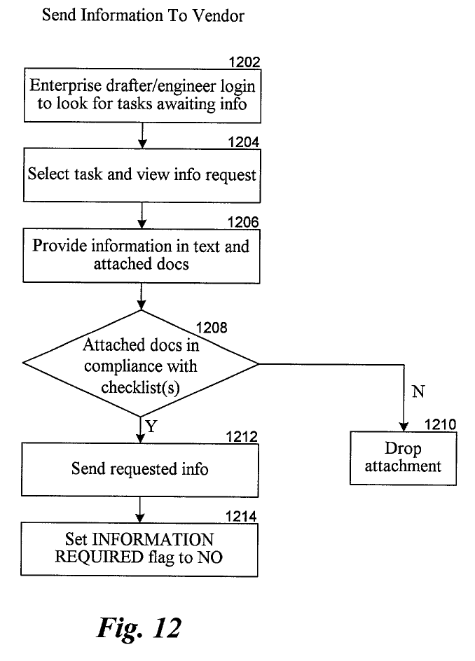

FIG. 12 is a flow diagram illustrating a use case in which enterprise personnel provide the task related information requested by vendor. At block 1202, an enterprise unit drafter/engineer logs into the VC application to look for any task awaiting information. The enterprise unit drafter/engineer can see a list of tasks in his or her own business group, but cannot see the tasks of the other business groups. At block 1204, the enterprise unit drafter/engineer selects a task awaiting information and views the detail of the additional information requested by the vendor. At block 1206, the enterprise unit drafter/engineer provides the requested information in running text format, with optional attached documents. At block 1208, it is determined whether the attached documents comply with any restrictions. In one embodiment, the enterprise unit drafter/engineer completes a checklist with information related to the attachments. The VC application evaluates the checklist and determines compliance or non-compliance with restrictions such as export restrictions. If the attachment(s) are not in compliance, the attachment(s) are dropped at block 1210. The enterprise unit drafter/engineer can attach different documents, modify the documents to bring them into compliance, or at block 1212, send the requested information. In the case of complying attachment documents, the requested information is sent at block 1212. An INFORMATION REQUIRED flag of the task is set to NO at block 1214.

In one embodiment, the enterprise unit drafter/engineer must set the flag affirmatively. In an alternate embodiment, the flag is automatically set when requested information is sent. Additional information on the assigned task can be sent by enterprise unit drafter/engineer iteratively during the process of work in progress. Table 6 is a list of data fields and sample data applicable to the use case of FIG. 12.

TABLE 6

| | Sample | |
|---|---|---|
| Field Name | Data | Remarks |
| Business | STM | Read Only. |
| Unit Code | | |
| Business | ES, EP | Read Only. |
| Group | | |
| Order | 1LX0269 | Read Only |
| Number | | |
| Activity | UJ8, | Read Only |
| Type Code/ Cost Code | UJ8DT, UJ9 | |
| Activity | CPLG | Read Only |
| Description | SPACER | |
| | PLATE, | |
| | LPB TE | |
| Vendor | SARD | Read Only |
| Outsource unit | | |
| VC | 1.5 | Read Only. |
| Estimated Hours | | |
| VC | 3/16/01 | Read Only |
| Requested Finish | | |
| date | | |
| Complexity | A, B, C, | Read Only |
| | D, 1234. | |
| Customer | ILLINOIS | Read Only |
| name | POWER CO | |
| | CLINTON | |
| Status | | Read Only. All the previous |
| History | | statuses and Dates which the |
| | | task under went. |
| Status | ASSIGNED/ | Read only |
| | IN | |
| | PROGRESS | |
| Requested | Free | READ ONLY |
| Information | format text | |
| Attachment | DOC, | READ ONLY |
| | XLS, GIF, | |
| | PDF,TXT etc: | |
| Sent | Free | enterprise Unit Drafter/ |
| Information | format text | Engineer keys in the |
| | | Information. |
| Sent | DOC, | enterprise Unit Drafter/ |
| attachment | XLS, GIF, | Engineer shall attach if required. |
| | PDF,TXT etc: | |
| Export | | enterprise Unit Drafter/ |
| Control Form | | Engineer shall fill in the Export |
| | | control form to comply the |
| | | attachment with outsourcing |
| | | rules. |
| INFORMATION | YES | Editable, enterprise Unit |
| SENT | | Drafter/Engineer shall change to |
| | | NO. |
| enterprise | | Read Only |
| Note | | |
| Initial- | JEH | Read Only |
| enterprise initiator | | |
| Responsible | AEH | Read Only. |
| Initial | | |
| Design | YES/NO | Read Only |
| Change Reference | | |
| Number Type | | |
| USER ID | | Automated |
| TIME | DATE: | Automated. |
| STAMP | TIME | |

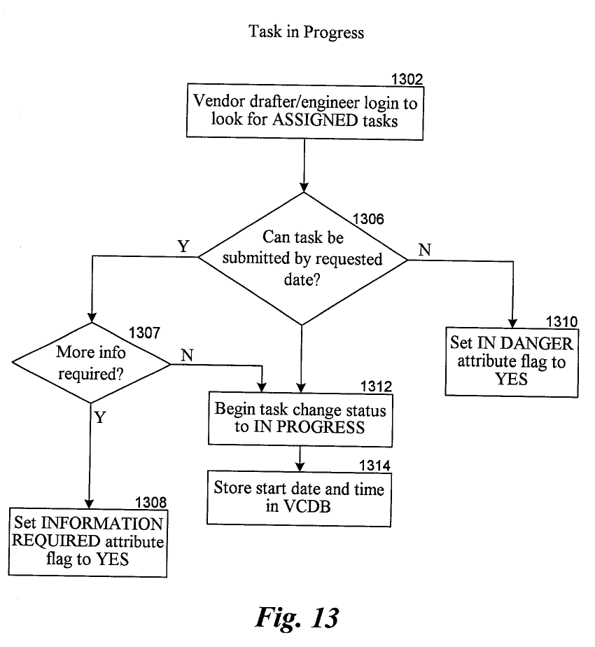

FIG. 13 is a flow diagram illustrating a use case that allows the vendor drafter/engineer personnel to acknowledge and work on the assigned task. At block 1302, the vendor drafter/engineer logs into the VC application to look for any tasks whose status is ASSIGNED. The vendor drafter/engineer can see the list of tasks that require processing, but cannot see tasks of other vendors. If the vendor drafter/engineer determines that the task cannot be completed by the requested data, at block 1306, the vendor drafter/engineer sets an IN DANGER attribute flag to YES at block 1310. If the vendor drafter/engineer determines that more information is required form the enterprise to work on the task, at block 1307, the INFORMATION REQUIRED attribute flag is set to YES at block 1308. Otherwise, the vendor drafter/engineer begins work on the task at block 1312 and changes the task status to IN PROGRESS. The work start date and time are stored in the VCDB at block 1314. Table 7 is a list of data fields and sample data applicable to the use case of FIG. 13.

TABLE 7

| | Sample | |
|---|---|---|
| Field Name | Data | Remarks |
| Business | STM | Read Only. |
| Unit Code | | |
| Business | ES, EP | Read Only. |
| Group | | |
| Order | 1LX0269 | Read Only |
| Number | | |
| Activity | UJ8, | Read Only |
| Type Code/ Cost Code | UJ8DT, UJ9 | |
| Activity | CPLG | Read Only |
| Description | SPACER | |
| | PLATE, | |
| | LPB TE | |
| Vendor | SARD | Read Only |
| Outsource unit | | |
| VC | 1.5 | Read Only. |
| Estimated Hours | | |
| VC | 3/16/01 | Read Only |
| Requested Finish | | |
| date | | |
| Complexity | A, B, C, | Read Only |
| | D, 1234. | |
| Customer | ILLINOIS | Read Only |
| name | POWER CO | |
| | (CLINTON) | |
| Status | | Read Only. All the previous |
| History | | statuses and Dates which the |
| | | task under went. |
| Status | ASSIGNED | Read only, shall change to |
| | | ‘IN PROGRESS’ once the |
| | | Vendor Drafter/Engineer starts |
| | | working on the task. |
| Delivery In | | Check Box shall be provided |
| Danger | | to indicate incase the dead line |
| | | cannot be met. |
| INFORMATION | YES/NO | Editable. |
| REQUIRED | | |
| Requested | Free | READ ONLY |
| Information | format text | |
| Attachment | DOC, | READ ONLY |
| | XLS, GIF, | |
| | PDF,TXT etc: | |
| Sent | Free | READ ONLY |
| Information | format text | |
| Sent | DOC, | READ ONLY |
| attachment | XLS, GIF, | |
| | PDF,TXT etc: | |
| enterprise | | Read Only |
| Note | | |
| Initial- | JEH | Read Only |
| enterprise initiator | | |
| Responsible | AEH | Read Only. |
| Initial | | |
| Design | YES/NO | Read Only |
| Change Reference | | |
| Number Type | | |
| USER ID | | Automated |
| TIME | DATE: | Automated. |
| STAMP | TIME | |

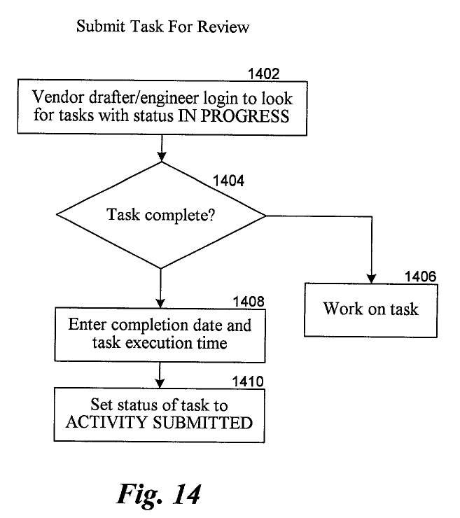

FIG. 14 is a flow diagram illustrating a use case that allows vendor drafter/engineer personnel to submit the completed task to the enterprise unit for review. At block 1402, a vendor drafter/engineer logs into the VC application to looks for any tasks whose status is in IN PROGRESS. The vendor drafter/engineer can see a list of tasks in progress, but cannot see tasks of other vendors. The vendor drafter/engineer determines whether the task is complete at block 1404. If the task is not complete, the vendor drafter/engineer works on the task at block 1406. If the task is complete, the vendor drafter/engineer enters the completion date and task execution time in hours at block 1408. The status of the task is set to ACTIVITY SUBMITTED at block 1410. Table 8 is a list of data fields and sample data applicable to the use case of FIG. 14.

TABLE 8

| | Sample | |
|---|---|---|
| Field Name | Data | Remarks |
| Business | STM | Read Only. |
| Unit Code | | |
| Business | ES, EP | Read Only. |
| Group | | |
| Order | 1LX0269 | Read Only |
| Number | | |
| Activity | UJ8, | Read Only |
| Type Code/ Cost Code | UJ8DT, UJ9 | |
| Activity | CPLG | Read Only |
| Description | SPACER | |
| | PLATE, | |
| | LPB TE | |
| Vendor | SARD | Read Only |
| Outsource unit | | |
| VC | 1.5 | Read Only. |
| Estimated Hours | | |
| VC | 3/16/01 | Read Only |
| Requested Finish date | | |
| Complexity | A, B, C, | Read Only |
| | D, 1234. | |
| Customer | ILLINOIS | Read Only |
| name | POWER CO | |
| | (CLINTON) | |
| Status | | Read Only. All the previous |
| History | | statuses and Dates which the |
| | | task under went. |
| Status | IN | Read only, shall change to |
| | PROGRESS | ‘ACTIVITY SUBMITTED’ |
| | | once the Vendor Drafter/ |
| | | Engineer completes and Submits |
| | | the task. |
| Delivery In | | Read Only |
| Danger | | |
| INFORMATION | NO | READ ONLY |
| REQUIRED | | |
| Actual | Date: | Editable, Vendor Drafter/ |
| Finish Date | Time | Engineer will key in the task |
| | | completion date. |
| Actual Hours | Time in | Editable, Vendor Drafter/ |
| | hrs: | Engineer will key in the time |
| | | spent for the task. |
| Requested | Free | READ ONLY |
| Information | format text | |
| Attachment | DOC, | READ ONLY |
| | XLS, GIF, | |
| | PDF,TXT etc: | |
| Sent | Free | READ ONLY |
| Information | format text | |
| Sent | DOC, | READ ONLY |
| attachment | XLS, GIF, | |
| | PDF,TXT etc: | |
| enterprise | | Read Only |
| Note | | |
| Initial- | JEH | Read Only |
| enterpnse initiator | | |
| Responsible | AEH | Read Only. |
| Initial | | |
| Design | YES/NO | Read Only |
| Change Reference | | |
| Number Type | | |
| USER ID | | Automated |
| TIME | DATE | Automated |
| STAMP | TIME | |

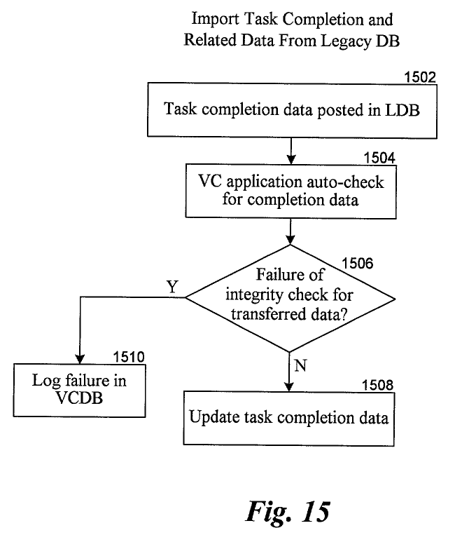

FIG. 15 is a flow diagram illustrating a use case that allows the VC application to import task completion-related information for previously assigned tasks from the legacy system. At block 1502, task completion data is posted in the legacy database. At block 1504, the VC application automatically checks the legacy database for any task completion data related to outsourced task on a regular basis, such as daily. In one embodiment, relevant records in the legacy database can be identified by updated time stamp, responsible unit, business unit, order number and activity type. The data fields related to existing task to be extracted from the legacy database are business code, order number, activity type code, actual finish date, actual hours, responsible unit and time stamp.

The VC application administrator may view and print a log that describes all of the data import activity from the legacy database to the VCDB.

At block 1506, and integrity check failures for transferred data are detected. If there is an integrity check failure, the failure is logged in the VCDB at block 1510 for later investigation by an enterprise administrator. If no integrity check failure is detected, task completion data, such as the actual finish date and actual hours, are updated in the VCDB at block 1508. Data integrity is verified, in once embodiment, with the following master data of VC: business unit code and responsible unit code. Table 9 is a list of data fields and sample data applicable to the use case of FIG. 15.

TABLE 9

| | Sample | |
|---|---|---|
| Field Name | Data | Remarks |
| Business | STM | This field is a part of Primary Key |
| Code | | |
| (tistiact.bus_code) | | |
| Order | 1LX0269 | L means the order is large. There can be multiple tasks under |
| Number | | an order. This field is a part of Primary Key |
| (tistiact.order_no) | | |
| Activity | UJ8PK, | If same activity type UJ8 comes more than once under same |
| Type Code/ Cost Code | UJ8, UJ8DT, | order with different suffixes; UJ8PK-The total work package,UJ8DT- |
| (tistiact.act_no) | JU8RW, UJ9 | task for the identified vendor, UJ8-the review task for enterprise, |
| | | UJ8RW-Rework by vendor. This field is a part of Primary Key. |
| Activity | CPLG | |
| Description | SPACER PLATE, | |
| (tistiact.act_desc) | LPB TE | |
| Actual | 3/16/01 | |
| Finish Date | | |
| (tistiact.actual_finish) | | |
| Actual Hours | 1.9 | 6 Minutes is 0.1 hrs. |
| (tistiact.hrs_actual) | | |
| Responsible | SARD | This is the responsible unit of a specific vendor for specific |
| unit | | enterprise business group. |
| (tistiact.resource_comp) | | |
| Requested | 1.5 | |
| Hour | | |
| (tistiact.req_hes_curr) | | |
| Late Finish | 3/16/01 | Late finish date of parent has to be considered if activity type |
| Date | | is ‘DT’ for requested finish date calculation if there is a packaged task. |
| (tistiact.curr_late_finish) | | |
| Target | 3/16/01 | |
| Finish date | | |
| (tistiact.target_finish) | | |
| Responsible | JEH | Initial of the person responsible for delivering the task |
| initial | | |
| (tistiact.resp_init) | | |
| Design | | |
| Change Reference | | |
| Number activity Type | | |
| Customer | ILLINOIS | Do a join on tisthead table and tistiact table using order no: as |
| name | POWER CO | common key |
| (tisthead.cust_name) | (CLINTON) | |
| Measurement | N | The ‘Y’ field is blank. |
| Indicator | | |
| (tistiact.measurement_ind) | | |
| Complexity | A, B, C, | |
| (tistiact.complexity) | D, 1234. | |
| Time Stamp | | This is in binary format |

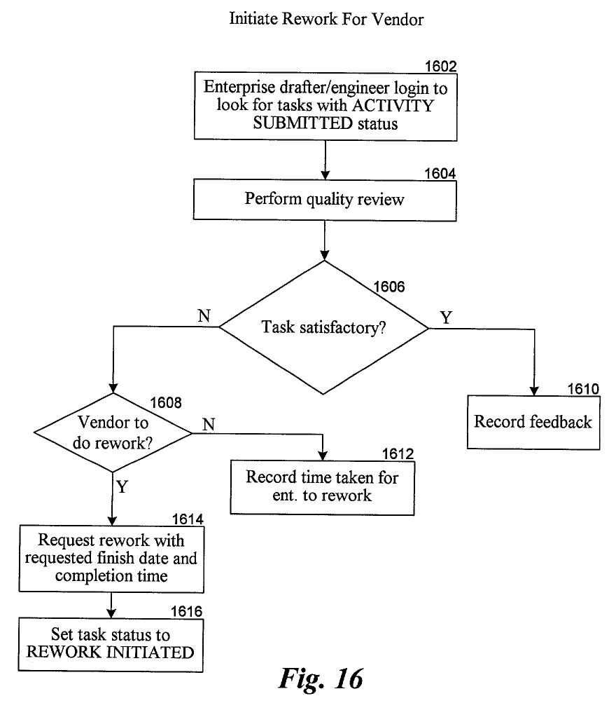

FIG. 16 is a flow diagram of illustrating a use case that allows an enterprise unit drafter/engineer to review a submitted task. At block 1602, the enterprise drafter/engineer logs into the VC application to look for any tasks whose status is ACTIVITY SUBMITTED. The enterprise drafter/engineer can see the list of tasks submitted for review, but cannot see the tasks of the other enterprise groups. At block 1604, the enterprise drafter/engineer performs a quality review of the task, and determines, at block 1606, whether the task is satisfactory. If the task is satisfactory, the enterprise drafter/engineer records feedback to the vendor at block 1610.

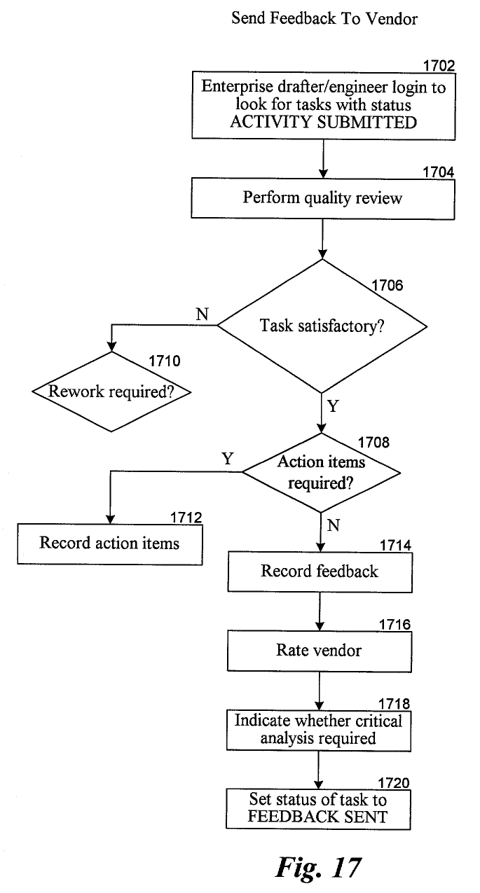

If the task is not satisfactory, the enterprise drafter/engineer decides, at block 1608, whether the vendor or the enterprise is to perform rework. If the enterprise performs the rework, the time taken for the enterprise rework is entered at block 1612. If the vendor is to perform the rework, the enterprise drafter/engineer submits a request for rework including a requested finish date and a completion time at block 1614. The status of the task is set to REWORK INITIATED at block 1616. FIG. 17 is a flow diagram illustrating a use case that allows an enterprise unit drafter/engineer to send feedback to the vendor after quality review of a task. The enterprise drafter/engineer logs into the VC application to look for any tasks whose status is ACTIVITY SUBMITTED in block 1702. The enterprise drafter/engineer can see a list of tasks submitted for review, but cannot see tasks of other vendors.

The enterprise drafter/engineer performs the quality review at block 1704, and determines if the task is satisfactory at block 1706. If the task is not satisfactory, rework is required, as shown at block 1710. The enterprise drafter/engineer determines whether actions items should be initiated at block 1708. If action items are to be initiated, the action items are recorded at block 1712. Otherwise, feedback to the vendor is recorded at 1714. The enterprise drafter/engineer also rates the vendor at block 1716 according to a predetermined rating system, such as ratings of 1 to 10, with 10 being the most satisfactory.

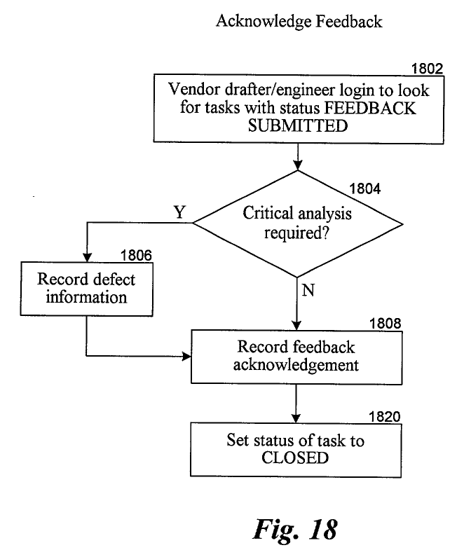

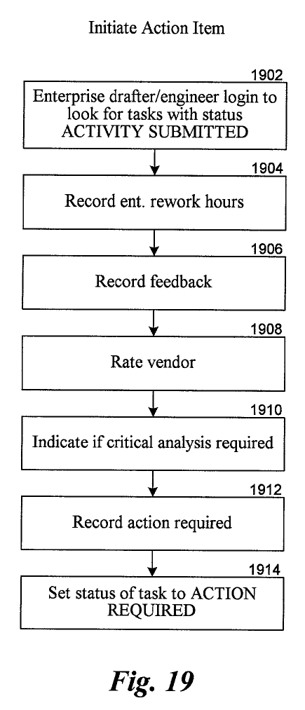

Critical analysis of some tasks may be required. The critical analysis may be performed by the vendor. If critical analysis is required, the enterprise drafter/engineer indicates this at block 1718. The status of the task is set to FEEDBACK SENT at block 1720. FIG. 18 is a flow diagram illustrating a use case that allows a vendor drafter/engineer to acknowledge feedback after the quality review. The vendor drafter/engineer logs into the VC application to look for vendor tasks with the status FEEDBACK SUBMITTED at block 1802. The vendor drafter/engineer can see a list of task with status FEEDBACK SUBMITTED, but cannot see the tasks of other vendors. The vendor drafter/engineer can determine whether critical analysis is required at block 1804 by seeing the record entered into the task by the reviewing enterprise drafter/engineer. If critical analysis is required, the vendor drafter/engineer performs the analysis and records defect statistics information, such as a number of critical defects and a number of non-critical defects, at 1806. The vendor drafter/engineer acknowledges the feedback in running text format at block 1808. On acknowledgement of feedback and defect statistics submission the status of the task is automatically set to CLOSED at block 1820. FIG. 19 is a flow diagram illustrating a use case that allows the enterprise unit drafter/engineer to send feedback and action items to a vendor after quality review of a task. The enterprise drafter/engineer logs into the VC application to look for any tasks whose status is ACTIVITY SUBMITTED at block 1902. The enterprise drafter/engineer can see a list of tasks with status ACTIVITY SUBMITTED, but cannot see the tasks of other enterprise groups.

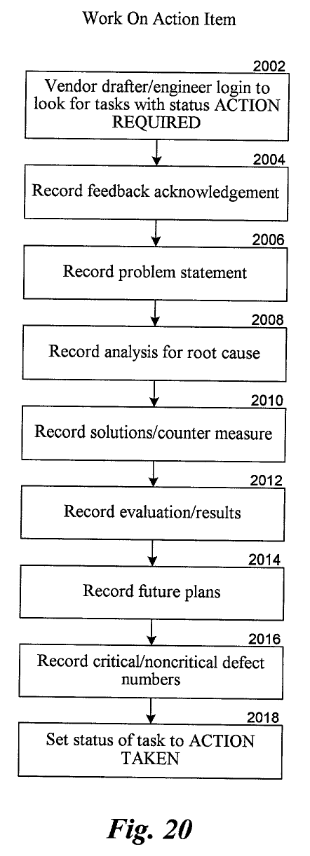

If the enterprise has performed any rework on the task, the number of hours required for the rework is recorded at block 1904. Feedback to the vendor is entered at block 1906, and the vendor is rated according to a predetermined rating system, at block 1908. If critical analysis is required, this is indicated at block 1910. If action items are required, the action required is entered at block 1912. For example, in one embodiment, if the date of submission of the assigned task by the vendor exceeds the requested finish date, an action item is mandatory. After the entries of blocks 1904, 1906, and 1908, the status of the task is automatically set to ACTION REQUIRED at block 1914. FIG. 20 is a flow diagram illustrating a use case that allows a vendor drafter/engineer to acknowledge feedback and undertake necessary follow-up action after quality review of a task. The vendor drafter/engineer logs into the VC application to look for any tasks whose status is ACTION REQUIRED at block 2002. The vendor drafter/engineer can see the tasks with status ACTION REQUIRED, but cannot see tasks of other vendors. The vendor drafter/engineer records acknowledgement of enterprise feedback at block 2004. The vendor drafter/engineer can record a problem statement at block 2006, and record an analysis to determine a root cause of problems requiring rework at block 2008. solutions and/or counter measures arrived at by the vendor drafter/engineer are recorded at block 2010. An evaluation of the rework, and results of the rework are recorded at block 2012. Any relevant future plans for dealing with similar tasks are recorded at block 2014. Results of critical analysis, including defect statistics such as a number of critical defects and a number of non-critical defects, is recorded at block 2016. The status of the task of then set to ACTION TAKEN at block 2018.

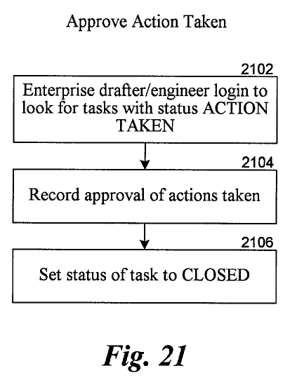

FIG. 21 is a flow diagram illustrating a use case that allows an enterprise unit drafter/engineer to approve the actions taken by the vendor. The enterprise unit drafter/engineer logs into the VC application to look for any tasks whose status is ACTION TAKEN at block 2102. The enterprise drafter/engineer cannot see tasks of other enterprise groups. The enterprise drafter/engineer must approve the actions taken on the task, for example in running text format, at block 2104. When the action taken is approved the status of the task is automatically set to CLOSED at block 2106.

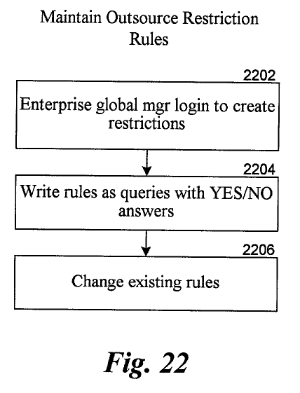

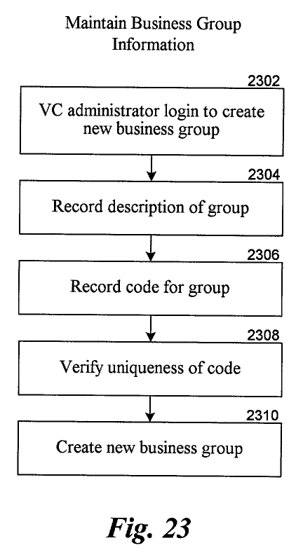

FIG. 22 is a flow diagram illustrating a use case that allows an enterprise high level general manager to maintain outsource restrictions. The enterprise general manager (“GM”) logs into the VC application to create and update outsource restrictions at block 2202. The enterprise GM may write any number of restriction rules in free text format at block 2204. In one embodiment, the rules are written as queries that each have a YES or NO answer. The enterprise GM can change the existing rules in a variety of ways. For example, existing rules can be made more explicit, rules can be added, and rules can be deleted. The updated rules are applicable to any new outsourced tasks and to any attached documents sent between the enterprise and a vendor. FIG. 23 is a flow diagram illustrating a use case that allows an enterprise administrator to maintain business group information. This use case is one of several use cases in which an enterprise administrator maintains the VC information. The VC information includes: a master list of enterprise business groups; a master list of business unit information; a master list of vendor information; and a master list of vendor outsource unit information. The several use cases relating to maintaining the VC information are similar. The use case for maintaining business group information will be given as an example of these use cases. Similar use cases exist for maintaining business unit information, maintaining vendor information, and maintaining vendor outsource unit information.

The enterprise VC administrator logs into the VC application to create a new enterprise business group at block 2302. At block 2304, the enterprise VC administrator records a description of the group. At block 2306, the enterprise VC administrator records a unique code for the group. The uniqueness of the code is automatically verified at block 2308. The new business group is created at block 2310. The business group information cannot be modified or deleted thereafter, except the enterprise VC administrator can change the description of the business group as required to make the description more current or complete.

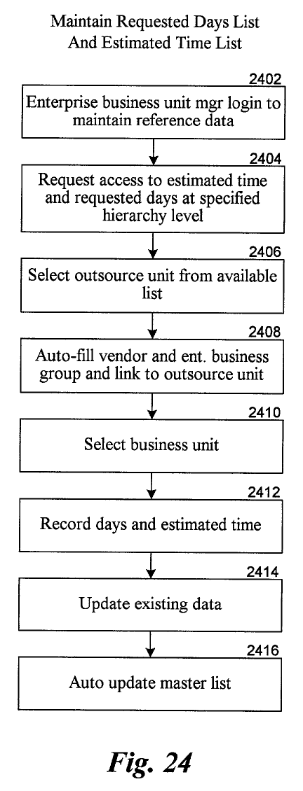

FIG. 24 is a flow diagram illustrating a use case that allows an enterprise business unit manager to create and maintain cross reference data on time required by a vendor to complete a task, such as requested number of days to complete a task, and estimated time for a vendor to complete the task.

The enterprise business unit manager logs into the VC application to maintain reference data at block 2402. The VC application enables the enterprise business unit manager to create “estimated time and requested days” at the business group level, the business unit level, and the vendor and outsource unit levels. The enterprise business unit manager requests access to “estimated time and requested days” at a specified level of hierarchy at block 2404. The enterprise business unit manager selects an outsource unit from an available list (for example, from a pull-down menu) at block 2406. Vendor and enterprise business groups fields are automatically populated as they are linked with the selected outsource unit at block 2408. The enterprise business unit manager selects a business unit at block 2410. The enterprise business unit manager then records the “estimated time and requested days” at block 2412. If “estimated time and requested days” information is already present, the information can be updated by the enterprise business unit manager at block 2414. The master list is automatically updated to reflect any recorded information at block 2416.

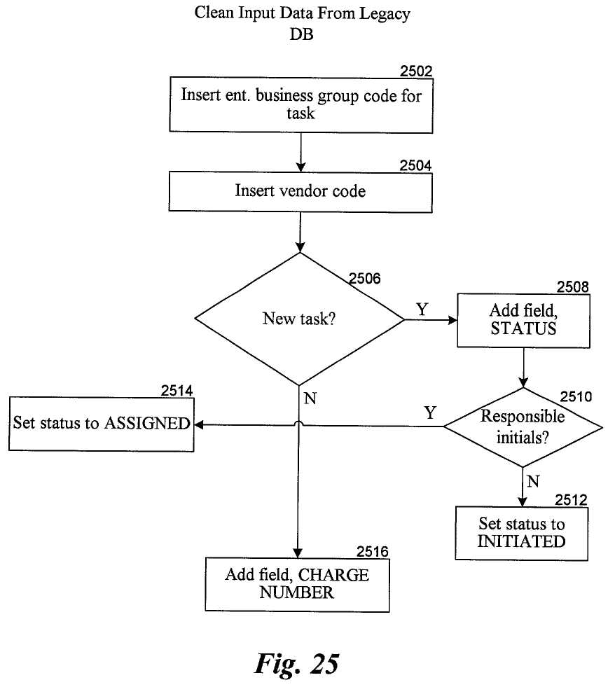

FIG. 25 is a flow diagram illustrating a use case in which the VC application “cleans” input data from a legacy application. Cleaning data includes redefining data elements imported from the legacy application and also defining new attributes against the tasks. Defining new attributes includes inserting new data elements in VC database records. This use case occurs when a new outsourced task is available in the VC database. At block 2502, a business group code is inserted. In one embodiment, the business group codes inserted can depend on an outsource unit associated with the task. A vendor code is inserted at block 2504. The particular vendor code depends on an outsource unit code. At block 2506, it is determined whether the task is a new task. If the task is not new, a CHARGE NUMBER field is added at block 2516. If the task is new, a STATUS field is added at block 2508. If the RESPONSIBLE INITIAL field has data, as determined at block 2510, the status of the task is set to ASSIGNED at block 2514. If the RESPONSIBLE INITIAL field has no data, the status of the task is set to INITIATED at block 2512.

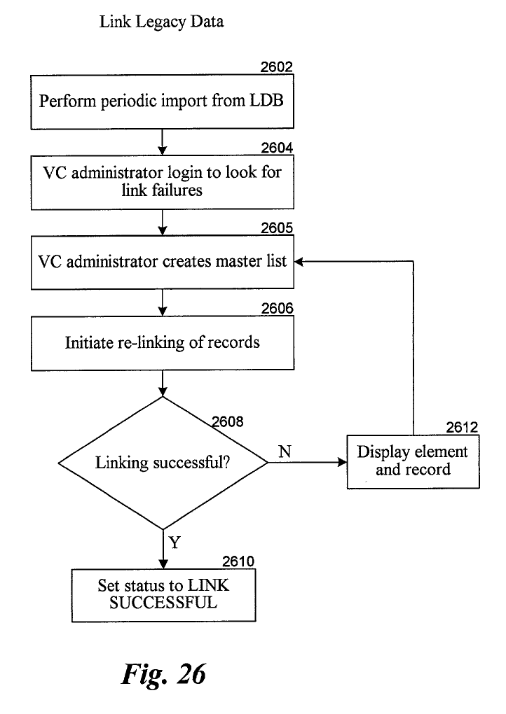

FIG. 26 is a flow diagram illustrating a use case in which the VC application integrates an imported task record from a legacy application to a set of reference/master data objects that exist in the VC application. The VC application performs periodic importation of data from the legacy database at block 2602. The VC administrator logs into the VC application at block 2604 to look for link failures that were previously recorded as they occurred. The VC administrator can view those tasks records that have link failures recorded against them and can identify task records which led to link failures. The VC administrator creates a corresponding master/reference data list at block 2605, and initiates re-linking of the record at block 2606. It is determined whether the re-linking was successful at block 2608. If the re-linking was successful, a status of the linking process is set to LINK SUCCESSFUL at block 2610. Otherwise, the record and data element associated with the re-linking failure are displayed at 2612. The process can be repeated for the failed record and data elements, starting with creating the master list at 2605. During the process of FIG. 26, any task involved in the re-linking process is unavailable to any other VC application process or user.

The VC application allows users to view specific types of information according to the level of privilege of the user. Some examples of data that can be viewed are given below.

Any user of the VC application can view an activity status master list for activities. The list is limited depending on the user's authorization level. For example, an enterprise GM can view every information related to every activity initiated by the enterprise, while a vendor drafter/engineer may be able to view information related to activities in his or her own vendor outsource unit. An activity status code and a related description of the activity are provided. Only an enterprise VC application administrator can change the description. The code cannot be changed.

A VC application administrator can view the possible application users and their respective access permissions. In one embodiment, the VC application has six user groups, enterprise GMs, enterprise business group managers, enterprise business group drafter/engineers, vendor managers, vendor unit drafter/engineers and administrators. Table 10 lists data that can be viewed by different actors and indicates whether the data can be modified.

TABLE 10

| | | |
|---|---|---|
| | Sample | |
| Field Name | Data | Remarks |

Access Permission for the Administrator

| | |
|---|---|
| Vendor | Add |
| Outsource Unit | |
| Responsible | Add and Modify |
| Contact Person of | |
| Vendor | |
| Import Data | View |
| Link | |
| Vendor | Add And Modify |
| Master | |
| Business | Add And Modify |
| Group | |
| Business | Add And Modify |
| Unit | |
| Activity | View |
| Status | |
| User Group | View |
| and Access | |
| User | Add and Modify |
| Creation | |
| Data Load | View |
| Log | |

Access Permission For Vendor Manager and Drafter/Engineer

| | |
|---|---|
| Task | View on Vendor specific task |
| Summary Report | |
| Task Detail | View and modify Vendor specific task |

Access Permission For enterprise Business Group Manager.

| | |
|---|---|
| Task | View on Business group related task |
| Summary Report | |
| Task Detail | View Business group related task |
| Request | Create and modify Business Group |
| Date and Estimated | related task |
| TIME Master | |

enterprise Business Group Drafter/Engineer

| | |
|---|---|
| Task | View on Business Group related task |
| Summary report | |
| Task Detail | View and modify on Business Group |
| | related task |

enterprise General Managers

| | |
|---|---|
| Outsource | Add and Modify |
| Restriction/ Export | |
| Control | |
| Task | View |
| Summary report | |
| Task Detail | View |

The VC application provides for the generation of various reports from the VCDB data. Some of the reporting capabilities of the VC application are described below. To produce a particular report, a user selects one or more filters to apply to the data. The available filters include:

requested finish date;

delivery in danger;

additional information requested; and

late finish date.

If no records are found after applying the selected filter(s), an error message such as “no match record found” is displayed. Table 11 lists data that can be viewed by different actors and indicates whether the data can be modified.

TABLE 11

| | Sample | |
|---|---|---|
| Field Name | Data | Remarks |
| Fields for | | |
| the selection card | | |
| Business | STM | Select/editable |
| Code | | |
| Business | ES, EP | Select |
| Division | | |
| Order | 1LX0269 | Editable |
| Number | | |
| Activity | UJ8, | Select/Editable |
| Type Code/ Cost Code | UJ8DT, UJ9 | |
| Responsible | SARD | Select/Editable |
| unit | | |
| Responsible | JEH | Select/Editable |
| initial | | |
| Date Type | Late | Select |
| | Finish, VC | |
| | Requested Finish | |
| From Date | Mm/dd/yy | Editable |
| To Date | Mm/dd/yy | Editable |
| Activity | IN | Select |
| Status | PROGRESS | |
| In Danger | YES/NO | Select |
| Information | YES/NO | Select |
| Requested | | |

Predefined reports are also available to the user. For example, a predefined status report can provide status information on the following:

tasks having late finish date between the selected ones;

requested finish date between the selected ones; and

delivery in danger and information requested.

The user can view only those task records that are related to the corresponding business group or outsource unit. Upon selecting a particular task from the available summary, the user can view or update detail on the task depending on the user's level of privilege. Table 12 lists data that can be viewed by different actors and indicates whether the data can be modified.

TABLE 12

| | Sample | |
|---|---|---|
| Field Name | Data | Remarks |
| Business | STM | Read only |
| Code [1] | | |
| Business | ES, EP | Read only |
| Group [2] | | |
| Order | 1LX0269 | Read only |
| Number | | |
| [5] | | |
| Activity | UJ8, | Read only |
| Type Code/ Cost Code | UJ8DT, UJ9 | |
| [4] | | |
| Responsible | SARD | Read only |
| unit | | |
| [3] | | |
| Estimated | 1.5 | Read only, This is legacy |
| Hours | | estimated hours |
| [10] | | |
| VC | | Read only |
| Estimated [11] Hours | | |
| Late Finish | 3/16/01 | Read only |
| Date | | |
| [12] | | |
| Target | | Read only, This is legacy |
| Finish Date [13] | | target finish date |
| VC | 3/16/01 | Read only |
| Requested Finish Date | | |
| [6] | | |
| Vendor | JEH | Read only |
| Responsible initial | | |
| [8] | | |
| Current | IN | Read only |
| Status [7] | PROGRESS etc: | |
| Initial- | JEH | Read only |
| enterprise initiator | | |
| [9] | | |
| Vendor | EDS | Read Only |
| Code [14] | | |
| Complexity | A, B, C | Read Only |
| [15] | | |
| In Danger | YES/NO | Read Only |
| [16] | | |
| Information | YES/NO | Read Only |
| Required [17] | | |

Another predefined report includes the following data:

quality review dates;

action items completed;

items waiting feedback; and

items waiting feedback acknowledgement. Table 13 lists data that can be viewed by different actors and indicates whether the data can be modified.

TABLE 13

| | Sample | |
|---|---|---|
| Field Name | Data | Remarks |
| Fields for | | |
| the selection card | | |
| Business | STM | Select/editable |
| Code | | |
| Business | ES, EP | Select |
| Division | | |
| Order | 1LX0269 | Editable |
| Number | | |
| Activity | UJ8, | Select/Editable |
| Type Code/ Cost Code | UJ8DT, UJ9 | |
| Responsible | SARD | Select/Editable |
| unit | | |
| Responsible | JEH | Select/Editable |
| initial | | |
| Date Type | Quality | Select |
| | review dates | |
| From Date | Mm/dd/yy | Editable |
| To Date | Mm/dd/yy | Editable |
| Activity | ACTION | Select |
| Status | TAKEN, | |
| | FEEDBACK | |
| | SENT, CLOSED, | |
| | ACTIVITY | |
| | SUBMITTED. | |

Another predefined report provides status information on the tasks having quality review date between user-selected dates, and other status, such as:

FEEDBACK SENT;

CLOSED; and

ACTION TAKEN.

The user can view only those task records which are related to the corresponding business group or outsource unit. Table 14 lists data that can be viewed by different actors and indicates whether the data can be modified.

TABLE 14

| | Sample | |
|---|---|---|
| Field Name | Data | Remarks |
| Business | STM | Read only |
| Code [1] | | |
| Business | ES, EP | Read only |
| Group [2] | | |
| Order | 1LX0269 | Read only |
| Number | | |
| [5] | | |
| Activity | UJ8, | Read only |
| Type Code/ Cost Code | UJ8DT, UJ9 | |
| [4] | | |
| Responsible | SARD | Read only |
| unit | | |
| [3] | | |
| Estimated | 1.5 | Read only, This is legacy |
| Hours | | estimated hours |
| [10] | | |
| VC | | Read only |
| Estimated [11] Hours | | |
| Late Finish | 3/16/01 | Read only |
| Date | | |
| [12] | | |
| Target | | Read only, , This is legacy target |
| Finish Date [13] | | finish date |
| VC | 3/16/01 | Read only |
| Requested Finish Date | | |
| [6] | | |
| Vendor | JEH | Read only |
| Responsible initial | | |
| [8] | | |
| Current | ACTION | Read only |
| Status [7] | TAKEN etc: | |
| Initial- | JEH | Read only |
| enterprise initiator | | |
| [9] | | |
| Vendor | EDS | Read Only |
| Code[14] | | |
| Complexity | A, B, C | Read Only |
| [15] | | |
| In Danger | YES/NO | Read Only |
| [16] | | |
| Information | YES/NO | Read Only |
| Required[17] | | |

The VC application further performs various calculations, such as calculating a requested finish date for an outsourced task. For a new outsourced task available in the VC database, the user may look up data regarding the number of days each vendor should take to complete a task at enterprise business unit, enterprise business group, vendor, outsource unit and activity type levels. For a new task, the requested date is calculated from the available late finish date of the task using a lookup.

In one embodiment, if a “target finish date” field is populated from the legacy database, it is not overwritten. The calculated VC requested date should not be beyond a “late finish date” if there is one.

Another calculation that can be performed is a calculation of the estimated time in hours for an outsourced task. This allows the VC application to create a new estimated/required time for each vendor to finish an activity. Information regarding approximate times in hours each vendor should take to complete a task is available in the VCDB at the levels of enterprise business unit, enterprise business group, vendor and outsource unit, and activity type. For a new task, and additional field for VC estimated time is inserted using the available lookup in the VCDB. Table 15 lists data that can be viewed by different actors and indicates whether the data can be modified.

TABLE 15

| | Sample | |
|---|---|---|
| Field Name | Data | Remarks |
| Fields for | | |
| the selection card | | |
| From Date | Mm/dd/yy | Editable |
| To Date | Mm/dd/yy | Editable |
| Fields in the | | |
| log summary | | |
| Load Type | New | Read Only |
| | Task, updated | |
| | task., | |
| Start Date | | Read Only |
| and Time | | |
| Finish Date | | Read Only |
| and Time | | |
| Load Status | Success, | Read Only |
| | Failure | |
| Number of | | Read Only |
| records | | |
| Failure Key | The | Read Only |
| | unique key of the | |
| | record in text | |
| | format, which the | |
| | process was trying | |
| | to load when it | |
| | failed | |

A VC application administrator can create application users and link them to user groups. The VC administrator must fill in or select the following field to create a new user profile:

User First Name;
User Last Name;
User Middle Name
User initial
Log In Id;
Password;
User Active (YES/NO);
User Group;
Business Group/Vendor;
Phone Number; and
e-mail Id;

When the VC administrator saves this profile, the uniqueness of the user initial is verified. The VC application users from the vendor side are responsible initials of the tasks. The initials of the common user of the legacy system and the VC application should be the same for data integrity. One default VC administrator user must be available to create other users. One VC administrator user can create additional VC administrator users. Table 16 lists data that can be viewed by different actors and indicates whether the data can be modified.

TABLE 16

| | Sample | |
|---|---|---|
| Field Name | Data | Remarks |
| First Name | | |
| Last Name | | |
| Middle | | |
| Name | | |
| User Initial | Char(4) | Should be unique. Refer to |
| | | tistsech.inits field of legacy DB to |
| | | identify Common users across |
| | | legacy and VC. |
| Log In Id | | |
| Password | | Encrypted |
| Active | YES/NO | If NO the user cannot login |
| User Group | | Select |
| enterprise | | Select |
| Business | | |
| Group/Vendor | | |
| Telephone | | Editable |
| Number | | |
| EMail ID | | Editable |
| Date/Time | | Automated |
| Administrator | | Automated |
| ID | | |

All the authorized VC application users can log into the VC application by supplying a valid login ID and password. The user has an option to change their user password.

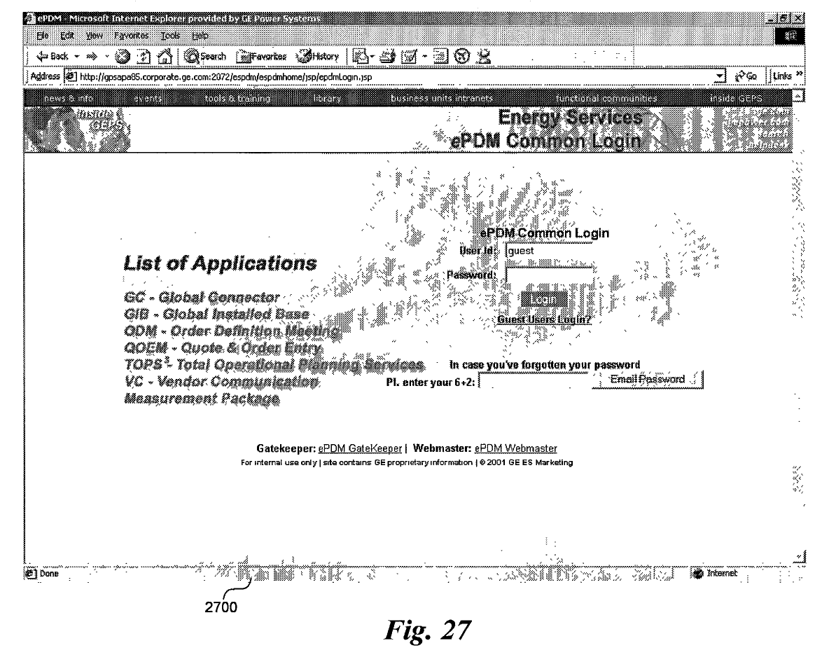

FIGS. 27-32 are examples of user interface screens intended for enterprise users. FIG. 27 is an illustration of a user interface login screen 2700 in one embodiment. The login screen 2700 includes a list of applications available to users associated with the Energy Services business unit of the enterprise, including the vendor communication (“VC”) application. The user can enter a user ID and password to access the VC application through the login screen 2700.

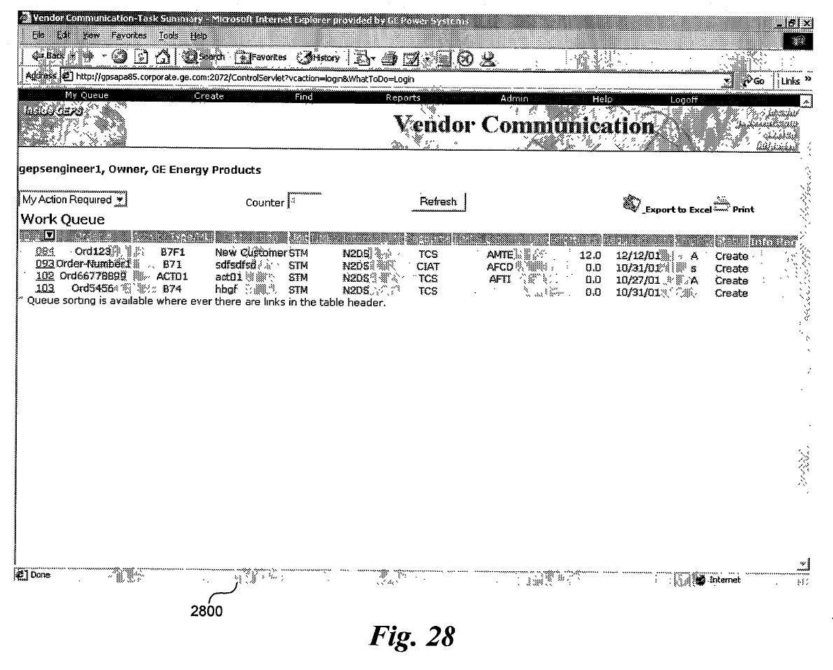

FIG. 28 is an illustration of a user interface work queue screen 2800 in one embodiment. The screen 2800 shows all of the tasks by order number for a particular user. The information provided in the work queue includes a task ID number, an order number (this may be an internal or external charge number, or a customer order number), a predefined activity type, a brief text description, an internal unit designation according to the legacy system, a resource designation (this indicates a vendor assigned a task), an external unit designation according to the legacy system, an estimated number of hours to complete the task, a required completion date, a complexity rating, and a status. The status “create” indicates that the task is waiting to be created by the user.

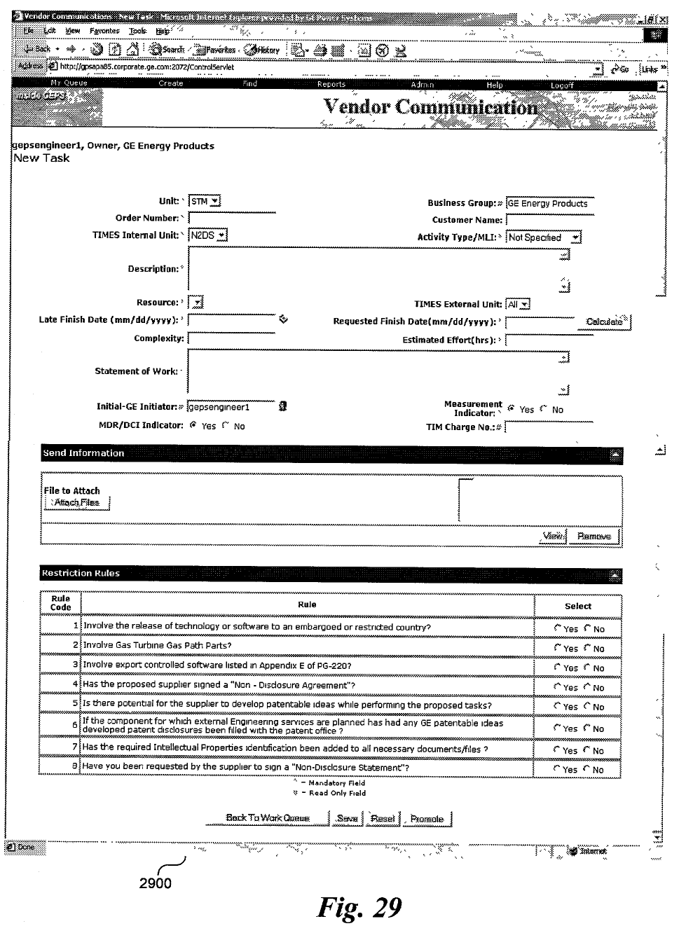

FIG. 29 is an illustration of a user interface new task screen 2900 in one embodiment. The user is presented with this screen after selecting one of the tasks in the previous work queue screen 2800. The information that is indicated, but not filled in, such as Order Number, is to be filled in by the enterprise user. The user can attach files by clicking on the attach files button and navigating to the file to be attached. The mandatory fields in the restriction rules checklist must be filled in for the task to be successfully created. The checklist is in the form of yes-no questions that lead the user to verify that the task as defined complies with the restrictions that were chosen to be placed on it. After the restriction rules checklist is completed by the enterprise user, it can only be changed by a manager or by the original author.

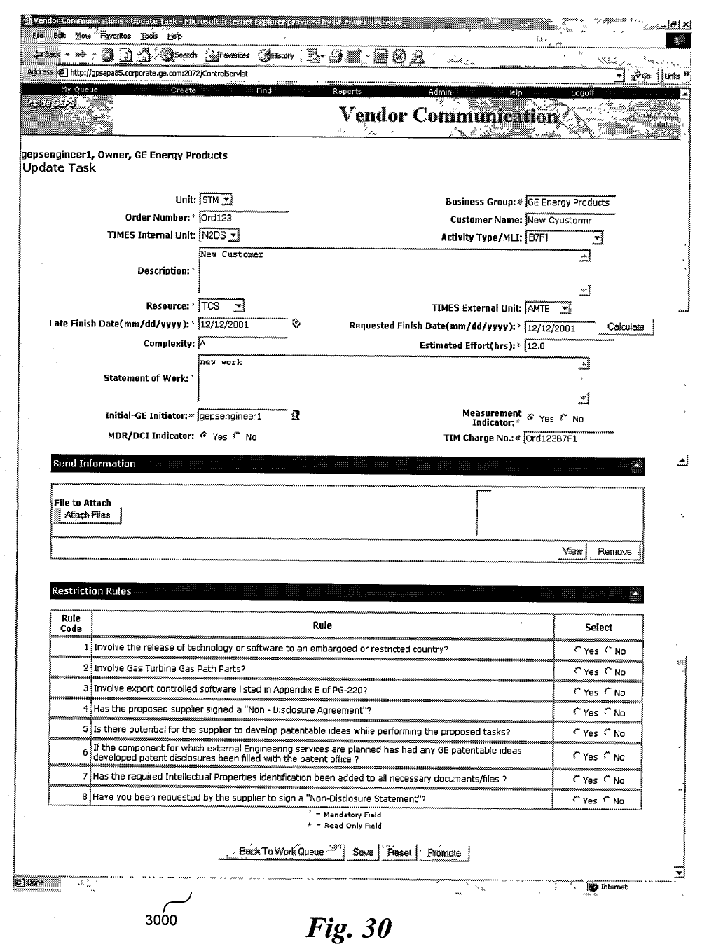

FIG. 30 is an illustration of a user interface update task screen 3000 in one embodiment. The screen 3000 displays information previously entered using the screen 2900. The information can be updated by the original author or a manager with an appropriate level of privilege.

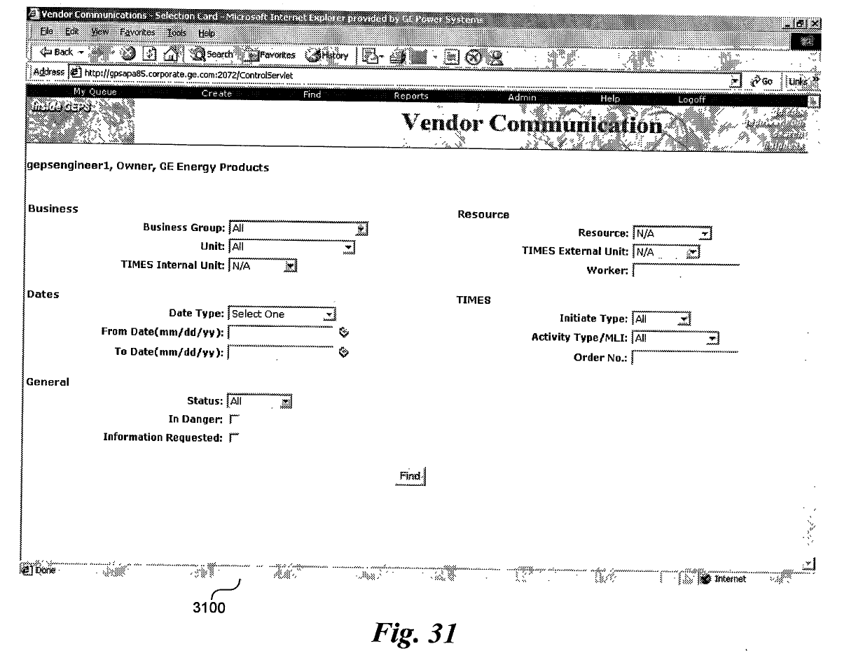

FIG. 31 is an illustration of a user interface search screen 3100 in one embodiment. The user can search through task data by entering information that would be found in one of the task fields as shown. The data searched includes all of the tasks that the user is privileged to view, and all of the predefined data such as codes for business groups, vendors, etc.

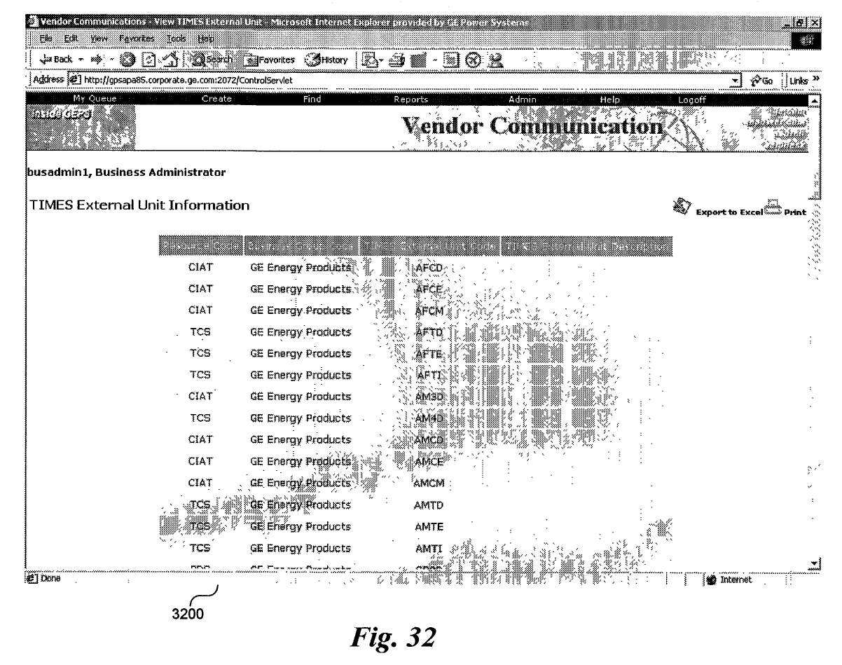

FIG. 32 is an illustration of a user interface search results screen 3200 in one embodiment. The screen shows the results of a search for all external unit codes according to the legacy system (the legacy system is called “Times” in this example). The results include a resource code and an external unit code for each external unit in the Energy Products business unit.

From the above description, it will be appreciated that through the specific embodiments of the configuration system that have been described for purposes of illustration, various modifications may be made without deviating from the scope of the invention. Accordingly, the invention is not limited, except by the following claims.

1. A method in a computer system for communication related to an outsourced task assigned to a vendor by an enterprise, comprising:
receiving at least one enterprise user input through a user interface to create an outsourced task, wherein the enterprise user input comprises a definition of the outsourced task and an identification of the vendor;
presenting an enterprise user with at least one checklist to be completed, wherein the at least one checklist refers to predefined restrictions;
receiving an enterprise user input that completes the at least one checklist;
evaluating the complete checklist for compliance with the predefined restrictions;
when the checklist is determined to comply with the predefined restrictions, setting a status of the outsourced task to “initiated”,
receiving at least one vendor input through the user interface, wherein the at least one vendor input comprises an indication of at least one vendor action related to completing the outsourced task;
setting a status of the task to indicate a current point in a predefined outsourced task lifecycle; and
storing data related to the outsourced task lifecycle in a vendor application database, including the enterprise inputs and the vendor inputs.

2. The method of 1, further comprising:
periodically searching a legacy database for legacy data related to outsourced tasks, wherein the information was entered using a legacy method; and
incorporating the legacy data into the vendor application database according to respective related outsourced tasks.

3. The method of 1, further comprising:
receiving an enterprise user input that comprises an assignment of the outsourced task to a vendor drafter/engineer; and
setting the status of the task to “assigned”.

4. The method of claim 1, further comprising:
receiving a vendor input that comprises a request for additional information related to the outsourced task; and
setting the status of the task to “information requested”.

5. The method of claim 4, further comprising:
receiving an enterprise input comprising the additional information; and
setting the status of the task to “information sent”.

6. The method of claim 5, wherein the request for additional information and the additional information each include documents in at least one format selected from a group comprising, DOC, TXT, XLS, GIF, PDF and TIFF.

7. The method of claim 1, further comprising:
receiving vendor input comprising an indication that a vendor drafter/engineer has begun the outsourced task; and
setting the status of the task to “in progress”.

8. The method of claim 1, further comprising:
receiving vendor input comprising an indication that the outsourced task cannot be completed by a predefined date; and
setting the status of the task to “delivery in danger”.

9. The method of claim 1, further comprising:
receiving vendor input comprising an indication that the outsourced task is completed; and
setting the status of the task to “activity submitted”.

10. The method of claim 9, further comprising:
receiving enterprise input comprising an indication that the outsourced task has been reviewed and is not satisfactory, including a specification of rework to be performed; and
setting the status of the task to “rework required”.

11. The method of claim 10, further comprising:
receiving vendor input comprising an indication that the specified rework has been undertaken; and
setting the status of the task to “rework initiated”.

12. The method of claim 9, further comprising:
receiving enterprise input comprising an indication that the outsourced task has been reviewed and an action item is required, including a specification of the action item; and
setting the status of the task to “action required”.

13. The method of claim 121, further comprising:
receiving vendor input comprising an indication that the action item has been performed; and
setting the status of the task to “action taken”.

14. The method of claim 13, further comprising:
receiving enterprise input comprising an indication that the action taken is satisfactory; and
setting the status of the task to “closed”.

15. The method of claim 9, further comprising:
receiving enterprise input comprising an indication that the outsourced task has been reviewed, including feedback to the vendor related to the outsourced task; and
setting the status of the task to “feedback sent”.

16. The method of claim 13, further comprising:
receiving enterprise input comprising an indication that the outsourced task has been reviewed and is not satisfactory, including a specification of rework to be performed; and
setting the status of the task to “rework required”.

17. A. method in a network for communication related to a task outsourced to a vendor by an enterprise, comprising:
presenting a user interface to different enterprise actors depending on an enterprise actor's level of privilege;
presenting at least one form to the enterprise actor to facilitate collection of specific data related to the task, wherein the specific data includes, a vendor to perform the task, a completion date of the task, import and export restrictions applicable to the task, feedback to the vendor regarding vendor performance, a specific action to be performed, whether the task performed by the vendor is satisfactory, and whether the task is complete;
presenting the user interface to different vendor actors depending on a vendor actor's level of privilege;
presenting at least one form to the vendor actor to facilitate collection of specific data related to the task, wherein the specific data includes,
the vendor has assigned the task to a vendor actor;
the vendor requires more information;
a delivery of the task is in danger due to specific circumstances;
and a specific required action has been taken;
setting a status of the task dependent upon the data collected; and
storing all of the data related to the task.

18. The method of claim 17, further comprising:
receiving input from the vendor actor regarding completion of the outsourced task;
receiving input from the enterprise actor regarding the outsourced task; and
setting a status of the task depending on the input received from the vendor actor and the enterprise actor.

19. The method of claim 18, wherein the outsourced task is a materials resource planning (“MRP”) task.

20. The method of claim 18, wherein the vendor actor comprises a vendor drafter/engineer, and a vendor manager.

21. The method of 20, wherein the enterprise actor comprises:
an enterprise drafting manager;
an enterprise drafter/engineer;
an enterprise general manager; and
an application administrator that administers an application that comprises the user interface.

22. A computer-readable medium containing a vendor communication application and a data structure for defining a lifecycle of an outsourced task that is outsourced by an enterprise to a vendor, the data structure comprising:
a plurality of status definitions, wherein each of the status definitions indicates a stage in the task lifecycle;
a plurality of user definitions, wherein each of the user definitions indicates one of a group selected from,
enterprise users including enterprise managers enterprise drafter/engineers, and at least one enterprise administrator, wherein the enterprise administrator administers the vendor communication application and the data structure; and
vendor users including vendor managers and vendor drafter engineers; and
a plurality of privilege levels assigned to the plurality of users, wherein the plurality of users access the data structure using the vendor communication application to input data related to the task lifecycle.

23. The computer-readable medium of claim 22, wherein the plurality of status definitions is set in response to input from the plurality of users.

24. The computer-readable medium of claim 22, wherein each of the plurality of privilege levels allows one of the plurality of users to access data in the data structure that applies to a task that the one user is assigned to.

25. The computer-readable medium of claim 24, wherein the task is outsourced by the enterprise to a particular vendor and wherein the one user of the plurality of users must be associated with at least one entity selected from a group comprising the enterprise and the particular vendor.

26. The computer-readable medium of claim 22, wherein the data related to the task lifecycle includes:
a definition of the task;
a vendor to whom the task is outsourced;
a request for more information regarding the task; and
data documenting compliance with predetermined task restrictions, wherein the status of the lifecycle task is prevented from being set to a different status unless the task restrictions are complied with.

27. A system for managing and documenting a lifecycle of an outsourced task that is outsourced to a vendor by an enterprise, the system comprising:
at least one server that runs a vendor communication (“VC”) application, wherein a plurality of enterprise users and vendor users access the VC application input data regarding the lifecycle of the task;
at least one vendor application database that contains information regarding the task; and
at least one legacy database that contains information regarding tasks previously documented using a legacy application, wherein the VC application accesses the legacy database to automatically extract data regarding the previously documented tasks, and wherein the extracted data is integrated by the VC application into the VC database.

28. The system of 27, further comprising an active broker that communicates with the VC application, the VC database, and the legacy database, wherein the active broker brokers objects between the VC application and the VC database and between the VC application and the legacy database.

29. The system of 27, wherein the VC application is accessed by a plurality of users according to a user hierarchy, the user hierarchy comprising:
at least one enterprise user, wherein the at least one enterprise user is associated with at least one enterprise group and at least one enterprise unit; and
at least one vendor user, wherein the at least one vendor user is associated with at least one vendor unit.

30. The system of claim 29, wherein the VC application manages data related to the lifecycle of the task, including:
receiving at least one enterprise user input through a user interface to create the task, wherein the enterprise user input comprises a definition of the task and an identification of the vendor;
presenting an enterprise user with at least one checklist to be completed, wherein the at least one checklist refers to predefined restrictions;
receiving an enterprise user input that completes the at least one checklist;
evaluating the complete checklist for compliance with the predefined restrictions;
when the checklist is determined to comply with the predefined restrictions, setting a status of the task to “initiated”;
receiving at least one vendor input through the user interface, wherein the at least one vendor input comprises an indication of at least one vendor action related to completing the task;
setting a status of the task to indicate a current point in the lifecycle of the task; and
storing data related to the lifecycle of the task in the VC database, including the enterprise inputs and the vendor inputs.

31. A. method in a network for communication related to a task outsourced to a vendor by an enterprise, comprising:
communicating with at least one enterprise server, comprising accessing a vendor communication application;
receiving data from the at least one enterprise server, wherein the data comprises information regarding the outsourced task and a vendor application user interface;
presenting different screens of the vendor application user interface to different vendor actors depending on a vendor actor's level of privilege;
presenting at least one form to the vendor actor to facilitate collection of specific data related to the task, wherein the specific data includes,
the vendor has assigned the task to a vendor actor;
the vendor requires more information;
a delivery of the task is in danger due to specific circumstances; and
a specific required action has been taken;
setting a status of the task dependent upon the data collected; and
sending all of the data related to the task to the at least one enterprise server.

32. The method of claim 31, wherein the outsourced task is a materials resource planning (“MRP”) task.

33. The method of claim 32, wherein the vendor actor comprises a vendor drafter/engineer, and a vendor manager.

34. A. method in a network for communication related to a task outsourced to a vendor by an enterprise, comprising:
presenting a user interface to different enterprise actors depending on an enterprise actor's level of privilege;
presenting at least one form to the enterprise actor to facilitate collection of specific data related to the task, wherein the specific data includes, a vendor to perform the task, a completion date of the task, import and export restrictions applicable to the task, feedback to the vendor regarding vendor performance, a specific action to be performed, whether the task performed by the vendor is satisfactory, and whether the task is complete;
sending data to at least one vendor computer via the network, wherein the data includes the user interface;
receiving data regarding the task from the at least one vendor computer via the network, wherein the data is entered by a vendor actor at the at least one vendor computer with the user interface;
setting a status of the task dependent upon the data collected; and
storing all of the data related to the task.

35. The method of claim 34, wherein the outsourced task is a materials resource planning (“MRP”) task.

36. The method of claim 34, wherein the vendor actor comprises a vendor drafter/engineer, and a vendor manager.

37. The method of 34, wherein the enterprise actor comprises:
an enterprise drafting manager;
an enterprise drafter/engineer;
an enterprise general manager; and
an application administrator that administers an application that comprises the user interface.

38. A system for managing and documenting a lifecycle of an outsourced task that is outsourced to a vendor by an enterprise, the system comprising:
at least one server means that runs a vendor communication (“VC”) application, wherein a plurality of enterprise users and vendor users access the VC application input data regarding the lifecycle of the task;
at least one vendor application database means that contains information regarding the task; and
at least one legacy database means that contains information regarding tasks previously documented using a legacy application, wherein the VC application accesses the legacy database to automatically extract data regarding the previously documented tasks, and wherein the extracted data is integrated by the VC application into the VC database.

39. The system of 38, further comprising an active broker means that communicates with the VC application, the VC database, and the legacy database, wherein the active broker means brokers objects between the VC application and the VC database and between the VC application and the legacy database.

40. The system of 38, wherein the VC application is accessed by a plurality of users according to a user hierarchy, the user hierarchy comprising:
at least one enterprise user, wherein the at least one enterprise user is associated with at least one enterprise group and at least one enterprise unit; and
at least one vendor user, wherein the at least one vendor user is associated with at least one vendor unit.

41. The system of claim 40, wherein the VC application manages data related to the lifecycle of the task, including:
receiving at least one enterprise user input through a user interface to create the task, wherein the enterprise user input comprises a definition of the task and an identification of the vendor;
presenting an enterprise user with at least one checklist to be completed, wherein the at least one checklist refers to predefined restrictions;
receiving an enterprise user input that completes the at least one checklist;
evaluating the complete checklist for compliance with the predefined restrictions;
when the checklist is determined to comply with the predefined restrictions, setting a status of the task to “initiated”;
receiving at least one vendor input through the user interface, wherein the at least one vendor input comprises an indication of at least one vendor action related to completing the task;
setting a status of the task to indicate a current point in the lifecycle of the task; and
storing data related to the lifecycle of the task in the VC database, including the enterprise inputs and the vendor inputs.
